(19) United States
(12) Patent Application Publication
(10) Pub. No.: US 2026/0265560 A1
(43) Pub. Date: Sep. 10, 2026

(54) AQUEOUS INK, INK CARTRIDGE AND INKJET RECORDING METHOD

(71) Applicant: CANON KABUSHIKI KAISHA, Tokyo (JP)

(72) Inventors: MAYU HARADA, Tokyo (JP); SUGURU USHIRO, Kanagawa (JP); NAOYA HATTA, Kanagawa (JP); TETSUYA KOSUGE, Kanagawa (JP)

(21) Appl. No.: 19/556,135

(22) Filed: Mar. 4, 2026

(30) Foreign Application Priority Data
Mar. 6, 2025 (JP) 2025-035132
Feb. 27, 2026 (JP) 2026-030492

(51) Int. Cl. C09D 11/38; B41J 2/175; C09D 11/037; C09D 11/322

(52) U.S. Cl. CPC C09D 11/38; C09D 11/037; C09D 11/322; B41J 2/17503

(57) ABSTRACT

To provide an aqueous ink which is excellent in fixation recoverability, which enables an image excellent in light resistance to be recorded, which less causes a foreign substance even if discharged through a thermal-type recording head and which is favorable in stability of the rate of discharge. An aqueous ink for inkjet containing C.I. Pigment Yellow 74 and a compound represented by general formula (1). A mass ratio of the compound represented by the general formula (1) adsorbed onto the C.I. Pigment Yellow 74 to the C.I. Pigment Yellow 74 present in the aqueous ink is 0.20% by mass or more. A mass ratio of the compound represented by the general formula (1) present inside the C.I. Pigment Yellow 74 to the C.I. Pigment Yellow 74 present in the aqueous ink is 0.70% by mass or less;

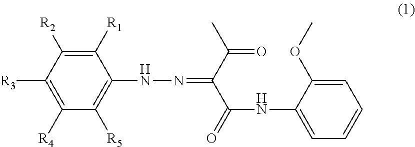

### BACKGROUND

### Field of the Technology

The present disclosure relates to an aqueous ink, an ink cartridge and an inkjet recording method.

### Description of the Related Art

Conventionally, pigments have been widely used as color materials for use in image recording by inkjet, from the viewpoint of toughness. In recent years, more highly color-developed images have been demanded and demands for increases in concentrations of pigments in pigment inks have been grown. On the other hand, increases in concentrations of pigments in aqueous inks easily cause aggregation or settling between pigment particles, and therefore aqueous pigment inks are required to have high performances in terms of clogging, discharge stability and the like of recording heads, as compared with conventional ones.

Monoazo pigments, in particular, inexpensive C.I. Pigment Yellow 74 characterized by being excellent in terms of hue and sharpness, are widely used as yellow pigments to be used in aqueous pigment inks for inkjet recording. However, C.I. Pigment Yellow 74 is easily crystallized, and easily deteriorates in coloring power and transparency, and also particle size stability, storage stability and the like when contained in inks. In order to improve such properties, pigment derivatives whose chemical structures are similar to that of C.I. Pigment Yellow 74 may be used in combination with C.I. Pigment Yellow 74.

For example, in Japanese Patent Laid-Open No. 2003-165919, use of, as a pigment derivative, a pigment derivative having a substituent soluble in an aqueous medium for inks, such as a carboxy group or a sulfo group, is proposed.

Specifically, it is disclosed that C.I. Pigment Yellow 74 is obtained by mixing a raw material of a pigment derivative having a solubilizing group with a raw material of C.I. Pigment Yellow 74 in synthesis of C.I. Pigment Yellow 74, thereby simultaneously synthesizing the pigment derivative (mixed coupling). It is indicated that transparency and coloring power of a color material can be thus enhanced.

### SUMMARY

The present disclosure is directed to providing an aqueous ink which is excellent in fixation recoverability, which enables an image excellent in light resistance to be recorded, which less causes a foreign substance even if discharged through a thermal-type recording head and which is favorable in stability of the rate of discharge. The present disclosure is also directed to providing an ink cartridge and an inkjet recording method in which the aqueous ink is used.

Specifically, according to one aspect of the present disclosure, there is provided an aqueous ink for inkjet, the aqueous ink containing C.I. Pigment Yellow 74 and a compound represented by the following general formula (1), wherein a mass ratio of the compound represented by the general formula (1) adsorbed onto the C.I. Pigment Yellow 74 to the C.I. Pigment Yellow 74 present in the aqueous ink is 0.20% by mass or more, and a mass ratio of the compound represented by the general formula (1) present inside the C.I. Pigment Yellow 74 to the C.I. Pigment Yellow 74 present in the aqueous ink is 0.70% by mass or less.

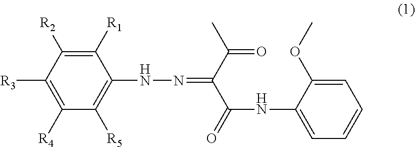

In the general formula (1), R₁ to R₅ each independently represent a hydrogen atom, a halogen atom, an alkyl group, an alkyl halide group, an alkoxy group, an acyl group, an aryl group, a nitro group, an alkoxycarbonyl group, an acyloxy group, a hydroxy group, an amino group, or a carboxy group, a sulfo group, a phosphoric acid group or a salt thereof. Alternatively, R₁ and R₂ can be bonded to each other to form an aromatic ring together with carbon atoms to which R₁ and R₂ are bonded. At least one of R₁ to R₅ is a hydroxy group, an amino group, or a carboxy group, a sulfo group, a phosphoric acid group or a salt thereof.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view schematically illustrating one embodiment of the ink cartridge of the present disclosure.

FIG. 2A is a perspective view schematically illustrating a main portion in one example of an inkjet recording apparatus for use in the inkjet recording method of the present disclosure.

FIG. 2B is a perspective view schematically illustrating a head cartridge in one example of an inkjet recording apparatus for use in the inkjet recording method of the present disclosure.

### DESCRIPTION OF THE EMBODIMENTS

Hereinafter, the present disclosure is further described in detail with reference to a illustrative embodiment. In the present disclosure, the aqueous ink for inkjet may be simply designated as “ink”.

In addition, “C.I.” means an abbreviation of “Color Index”. Furthermore, “unit” of a resin refers to a minimum repeating unit constituting the resin and means a unit structure which is a structure formed by (co)polymerization of one monomer and which corresponds to one monomer, unless particularly noted. In a case where “(meth)acrylic acid” and “(meth)acrylate” are designated, the respective designations represent “acrylic acid, methacrylic acid” and “acrylate, methacrylate”. In addition, “C.I. Pigment Yellow 74” may be referred to as “yellow azo pigment (P1)”, and “compound represented by formula (1)” may be referred to as “pigment derivative (P2)”.

The values of physical properties are each a value at ordinary temperature (25° C.), ordinary pressure (1 atm=101,325 Pa) and ordinary humidity (relative humidity 50%), unless particularly noted.

The present inventors have performed evaluation of an ink by use of, as an aqueous ink for inkjet, C.I. Pigment Yellow 74 obtained by mixed coupling of a pigment derivative having a solubilizing group in an aqueous medium for an ink, such as a carboxy group or a sulfo group, as described in Japanese Patent Laid-Open No. 2003-165919. As a result, it has been found that, in a case where a specified pigment derivative is used, fixation recoverability is favorable and clogging in discharge hardly occurs. Furthermore, it has been found that, even if the ink is discharged through a thermal-type recording head, generation of a foreign substance in the vicinity of a discharge port in the recording head can be suppressed and the landing position of an ink droplet on the recording medium can be inhibited from varying.

However, it has been found that, in a case where an image is recorded by use of the above ink, the image is reduced in light resistance of image when compared with an image recorded by an ink containing no pigment derivative. Furthermore, it has been found that, when the above ink is discharged through a thermal-type recording head, the rate of discharge may decrease despite a small amount of a foreign substance generated in the vicinity of a discharge port in the recording head.

Therefore, the present inventors have made intensive studies about an aqueous ink which is favorable in fixation recoverability, which enables an image excellent in light resistance to be recorded, which less causes a foreign substance even if discharged through a thermal-type recording head and which is favorable in stability of the rate of discharge, and as a result, have led to the present disclosure.

The present inventors have first specifically confirmed a pigment derivative for an enhancement in fixation recoverability. As a result, it has been revealed to be effective that a certain amount or more of a compound represented by the following general formula (1), which is the pigment derivative (P2), is adsorbed onto a surface of C.I. Pigment Yellow 74 which is the yellow azo pigment (P1).

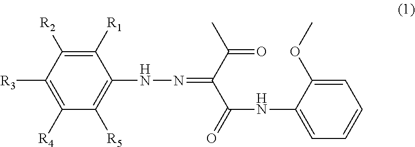

In the general formula (1), R₁ to R₅ each independently represent a hydrogen atom, a halogen atom, an alkyl group, an alkyl halide group, an alkoxy group, an acyl group, an aryl group, a nitro group, an alkoxycarbonyl group, an acyloxy group, a hydroxy group, an amino group, or a carboxy group, a sulfo group, a phosphoric acid group or a salt thereof. Alternatively, R₁ and R₂ can be bonded to each other to form an aromatic ring together with carbon atoms to which R₁ and R₂ are bonded. At least one of R₁ to R₅ is a hydroxy group, an amino group, or a carboxy group, a sulfo group, a phosphoric acid group or a salt thereof.

The present inventors presume the reason why fixation recoverability is enhanced by adsorption of the pigment derivative (P2) to C.I. Pigment Yellow 74, as follows.

A phenomenon of fixation of a pigment at a discharge port of a recording head is caused by clogging of a nozzle due to an ink around the discharge port being dried upon contact with air. The pigment derivative (P2) has a functional group (hereinafter, also referred to as “solubilizing group”) enhancing solubility in an aqueous medium for an ink, such as a hydroxy group, an amino group, a carboxy group, a sulfo group, a phosphoric acid group and a salt thereof. The pigment derivative (P2), which has the solubilizing group, adsorbed onto a surface of C.I. Pigment Yellow 74, resulting in an increase in hydrophilicity of the surface of C.I. Pigment Yellow 74. Therefore, it has been considered that a fixed product containing a pigment is easily re-dissolved even after drying of an ink and fixation recoverability is enhanced. In other words, it is important to provide a state where a certain amount or more of the pigment derivative (P2) having the solubilizing group is adsorbed onto the surface of C.I. Pigment Yellow 74.

The present inventors have also made studies about generation of a foreign substance and stability of the rate of discharge in ink discharge through a thermal-type recording head. An inkjet recording apparatus is present which includes a thermal-type recording head in which a heater as a heating element generating heat energy (electrothermal conversion element) is utilized to generate an air bubble and discharge an ink. It has been revealed that, in a case where the thermal-type inkjet recording apparatus is used to discharge the above aqueous ink, a foreign substance is less generated in the vicinity of a discharge port. A phenomenon in which a foreign substance is generated in the vicinity of a discharge port is assumed to be caused due to a pigment in a dispersed state destabilized on the heater heated for discharge of an ink droplet, the pigment being attached to and deposited on the vicinity of a discharge port of a recording head. The foreign substance, if much generated, can lead to shift in ink discharge and no discharge of the ink, and therefore generation of a foreign substance preferably less occurs.

The present inventors presume the reason why generation of a foreign substance around a discharge port in the recording head can be suppressed by adsorption of the pigment derivative (P2) to C.I. Pigment Yellow 74, as follows. The pigment derivative (P2) adsorbed onto a pigment surface of C.I. Pigment Yellow 74, resulting in an enhancement in hydrophilicity of the surface of C.I. Pigment Yellow 74 dispersed in the ink. Thus, it has been considered that a dispersed state of the pigment on the heater is inhibited from being destabilized, resulting in decreased generation of a foreign substance around a discharge port in the recording head. In other words, it is important also from the viewpoint of suppression of a foreign substance to provide a state where a certain amount or more of the pigment derivative (P2) having the solubilizing group adsorbed onto the surface of C.I. Pigment Yellow 74.

As a method for producing a pigment containing C.I. Pigment Yellow 74 as the yellow azo pigment (P1) and the compound represented by the general formula (1) as the pigment derivative (P2), use of mixed coupling is considered. However, in the case of use of a pigment obtained by mixed coupling, a new problem which has occurred is that, although fixation recoverability is at a non-problematic level, an image is reduced in light resistance as compared with an image recorded by an ink containing no pigment derivative (P2). Furthermore, it has also been found that, when an ink is discharged through a thermal-type recording head, the rate of discharge may decrease despite a foreign substance less present in the vicinity of a discharge port.

The present inventors have investigated the reason why light resistance of the resulting image is impaired, and as a result, it has been revealed that such impairment is caused due to the state of presence of the pigment derivative (P2). In a case where C.I. Pigment Yellow 74 is synthesized by mixed coupling, the pigment derivative (P2), although one portion of the pigment derivative adsorbed onto a surface of C.I. Pigment Yellow 74, is mostly incorporated inside a crystal of C.I. Pigment Yellow 74. It is presumed that the pigment derivative (P2) is incorporated inside a crystal of C.I. Pigment Yellow 74 to cause a reduction in crystallinity of C.I. Pigment Yellow 74 and cause a reduction in light resistance.

Furthermore, it has been revealed that impairment in stability of the rate of discharge in use of an inkjet recording apparatus including a thermal-type recording head is also caused due to the state of presence of the pigment derivative (P2). The pigment derivative (P2) is incorporated inside a crystal of C.I. Pigment Yellow 74 to cause a reduction in crystallinity of C.I. Pigment Yellow 74 and cause a reduction in heat resistance of C.I. Pigment Yellow 74. It is presumed that burning thus easily occurs on the heater. In other words, it is important from the viewpoint of light resistance and stability of the rate of discharge to consider the balance between the amount of adsorption to a pigment surface of C.I. Pigment Yellow 74 and the amount of presence inside the pigment of C.I. Pigment Yellow 74 also when the compound represented by the general formula (1) is present with being mixed with C.I. Pigment Yellow 74.

However, it has been revealed according to studies by the present inventors that, in a pigment obtained by mixed coupling of C.I. Pigment Yellow 74 and the pigment derivative (P2), both the amount of adsorption of the pigment derivative (P2) to a surface of C.I. Pigment Yellow 74 and the amount of the pigment dispersion present inside the pigment of C.I. Pigment Yellow 74 are difficult to appropriately control and light resistance and stability of the rate of discharge cannot be improved.

The reason for this is presumed as follows. In a case where C.I. Pigment Yellow 74 is synthesized by mixed coupling, one portion of the pigment derivative (P2) is incorporated inside a crystal of C.I. Pigment Yellow 74. Therefore, in order to satisfy the amount of adsorption of the pigment derivative (P2) to a surface of C.I. Pigment Yellow 74, necessary for obtaining the effects of an enhancement in fixation recoverability and of suppression of a foreign substance around a discharge port, the pigment derivative (P2) is required to be excessively added. On the other hand, an increase in amount of addition of the pigment derivative (P2) to C.I. Pigment Yellow 74 in mixed coupling leads to an increase in proportion of the pigment derivative (P2) present inside C.I. Pigment Yellow 74. As a result, a reduction in crystallinity of C.I. Pigment Yellow 74 is caused and reductions in light resistance and stability of the rate of discharge of C.I. Pigment Yellow 74 are caused.

It has been revealed as a result of studies by the present inventors that the mass ratio of the compound (P2) adsorbed onto C.I. Pigment Yellow 74 (P1) to C.I. Pigment Yellow 74 (P1) present in the ink is required to be 0.20% by mass or more from the viewpoint of an enhancement in fixation recoverability and suppression of a foreign substance around a discharge port. It has found that, when the mass ratio of the pigment derivative (P2) adsorbed onto C.I. Pigment Yellow 74 (P1) to C.I. Pigment Yellow 74 (P1) is 0.20% by mass or more, C.I. Pigment Yellow 74 can be re-dispersed even after drying and the ink can be inhibited from being fixed at a discharge port to cause clogging. Furthermore, it has been found that, when discharge is performed by a thermal system, C.I. Pigment Yellow 74 whose dispersion state is partially destabilized in discharge can be sufficiently dispersed. In addition, it has been thus found that generation of a foreign substance along with precipitation of a pigment attached in and deposited on an ink passage wall and a passage in the vicinity or the like of a discharge port can be suppressed.

It has also been revealed as a result of studies by the present inventors that the mass ratio of the pigment derivative (P2) present inside C.I. Pigment Yellow 74 to C.I. Pigment Yellow 74 present in the ink is required to be 0.70% by mass or less, from the viewpoint of light resistance and stability of the rate of discharge. If the mass ratio of the pigment derivative (P2) present inside C.I. Pigment Yellow 74 (P1) to C.I. Pigment Yellow 74 exceeds 0.70% by mass, crystallinity of C.I. Pigment Yellow 74 is reduced and light resistance is impaired. Furthermore, in a case where discharge is performed by a thermal system, C.I. Pigment Yellow 74 (P1) is reduced in crystallinity and is impaired in heat resistance, and the rate of discharge is reduced.

The present inventors have then selected, as one procedure for achieving the balance between the amount of adsorption of the pigment derivative (P2) adsorbed onto a surface of C.I. Pigment Yellow and the amount of the pigment dispersion present inside C.I. Pigment Yellow 74, as described above, a method in which, when a water-soluble yellow azo pigment derivative (P2) is contained, not mixed coupling is performed, but the pigment derivative (P2) is added as a dispersion aid in preparation of the ink, at a concentration equal to or less than the concentration allowing for full dissolution in the ink.

### <Aqueous Ink>

The ink of the present disclosure is an aqueous ink for inkjet, containing C.I. Pigment Yellow 74 and a pigment derivative (P2). Hereinafter, each component constituting the ink of the present disclosure and physical properties and the like of the ink are described in detail.

Here, the pigment derivative (P2) in the ink is present in various forms, and herein the pigment derivative (P2) present in a free form in the ink with not adsorbed onto C.I. Pigment Yellow 74 may be expressed as P2-A, the pigment derivative (P2) adsorbed onto C.I. Pigment Yellow 74 may be expressed as P2-B, and the pigment derivative (P2) present inside C.I. Pigment Yellow 74 may be expressed as P2-C. In addition, the total content of the pigment derivative (P2) in the ink is the sum of the contents of P2-A, P2-B and P2-C.

(Pigment Derivative (P2) Adsorbed onto Yellow Azo Pigment (P1))

The mass ratio of the pigment derivative (P2) adsorbed onto C.I. Pigment Yellow 74 to C.I. Pigment Yellow 74 as the yellow azo pigment (P1) present in the aqueous ink is 0.20% by mass or more. The mass ratio is the ratio (% by mass) of the mass (content) of the pigment derivative (P2) adsorbed onto C.I. Pigment Yellow 74 to the mass (content) of C.I. Pigment Yellow 74 present in the ink. The mass ratio may be expressed as the amount of adsorption of the pigment derivative (P2) to C.I. Pigment Yellow 74. The above mass ratio of the pigment derivative (P2) adsorbed onto the yellow azo pigment (P1) is 0.20% by mass or more, thereby enabling fixation suppression ability to be enhanced and furthermore enabling generation of a foreign substance in discharge through a thermal-type recording head to be reduced. From such a viewpoint, the mass ratio of the pigment derivative (P2) adsorbed onto the yellow azo pigment (P1) to C.I. Pigment Yellow 74 present in the ink is preferably 0.30% by mass or more, further preferably 0.50% by mass or more. In addition, the mass ratio of the pigment derivative (P2) adsorbed onto C.I. Pigment Yellow 74 to C.I. Pigment Yellow 74 present in the ink is preferably 2.00% by mass or less.

The amount of adsorption of the water-soluble yellow azo pigment derivative (P2) adsorbed onto C.I. Pigment Yellow 74 in the ink can be measured by the following method. First, a predetermined amount of the ink is subjected to a centrifugation treatment (56,000 rpm for 30 minutes) and the resulting supernatant is allowed to pass through a syringe filter having a pore size of 0.45 μm, to provide a sample solution for non-adsorption component measurement.

Next, a moderate amount of a solution in which dimethyl sulfoxide (DMSO) and water are mixed at a mass ratio of 1:1 is added to a sediment remaining after removal of the supernatant from a liquid after the above centrifugation treatment, and ultrasonic cavitation (40 kHz for 30 seconds) is performed. Thus, a suspension in which one portion of the pigment derivative (P2) adsorbed onto C.I. Pigment Yellow 74 is dissolved is obtained. The suspension is subjected to a centrifugation treatment (56,000 rpm for 30 minutes), and the resulting supernatant is allowed to pass through a syringe filter having a pore size of 0.45 μm, to provide a sample for measurement of the adsorbing pigment derivative (P2). The supernatant is again removed, and the same operation is repeated ten times. The total amount of the pigment derivative (P2) appearing in the supernatant by ten washing operations is defined as the amount of the pigment derivative (P2) adsorbed onto C.I. Pigment Yellow 74. In addition, the difference obtained by subtracting the amounts of a non-adsorption component and an adsorption component from the total amount of the pigment derivative (P2) present in the ink can be defined as the amount of the pigment derivative (P2) present inside C.I. Pigment Yellow 74.

### (Pigment Derivative (P2) Present Inside Yellow Azo Pigment (P1))

The mass ratio of the water-soluble yellow azo pigment derivative (P2) inside C.I. Pigment Yellow 74 to C.I. Pigment Yellow 74 as the yellow azo pigment (P1) present in the aqueous ink is 0.70% by mass or less. The mass ratio is the ratio (% by mass) of the mass (content) of the pigment derivative (P2) present inside C.I. Pigment Yellow 74 to the mass (content) of C.I. Pigment Yellow 74 present in the ink. The above mass ratio of the pigment derivative (P2) present inside C.I. Pigment Yellow 74 is 0.70% by mass or less, thereby enabling an ink favorable in stability of the rate of discharge in discharge through an inkjet-type recording head to be obtained. From such a viewpoint, the mass ratio of the pigment derivative (P2) present inside C.I. Pigment Yellow 74 to C.I. Pigment Yellow 74 present in the ink is preferably 0.50% by mass or less, further preferably 0.40% by mass or less.

### (Ratio of Pigment Derivative (P2) to Yellow Azo Pigment (P1))

The mass ratio of the water-soluble yellow azo pigment derivative (P2) to C.I. Pigment Yellow 74 as the yellow azo pigment (P1) is preferably 2.0% by mass or less. The mass ratio is the ratio (% by mass) of the total mass (total content) of the pigment derivative (P2) to the total mass (total content) of C.I. Pigment Yellow 74, present in the ink. The pigment derivative (P2) is dissolved in the ink and is present as a molecule. Therefore, the pigment derivative is lower in light resistance than a pigment particle having a crystal structure. When the mass ratio of the pigment derivative (P2) to C.I. Pigment Yellow 74 is 2.0% by mass or less, the proportion of a color material which is discolored in a case where an image is exposed to light over a long period is sufficiently small, and therefore a reduction in optical density from the initial stage can be suppressed.

In addition, the color tone of the ink can be inhibited from being shifted from the color tone of C.I. Pigment Yellow 74 by the influence of the color tone of the pigment derivative (P2) itself. The mass ratio of the yellow azo pigment derivative (P2) to C.I. Pigment Yellow 74 is more preferably 1.5% by mass or less, further preferably 1.2% by mass or less from the viewpoint of the above light resistance and color tone. On the other hand, the mass ratio of the pigment derivative (P2) to C.I. Pigment Yellow 74 is preferably 0.3% by mass or more, further preferably 0.5% by mass or more from the viewpoint that the above effect of suppression of generation of a foreign substance is easily enhanced.

### (Yellow Azo Pigment (P1))

The ink contains C.I. Pigment Yellow 74 as the yellow azo pigment (P1). The ink preferably contains C.I. Pigment Yellow 74 (hereinafter, also sometimes referred to as “PY74”) as a main pigment. Here, the main pigment is a pigment having the highest mass ratio among pigments contained in the ink.

In general, C.I. Pigment Yellow 74 is synthesized by coupling one obtained by formation of a diazonium salt of 2-methoxy-4-nitroaniline, as a diazo component, and o-acetoacetanisidide as a coupler component.

### (Pigment Derivative (P2))

The ink contains a compound represented by the following general formula (1), as the pigment derivative (P2).

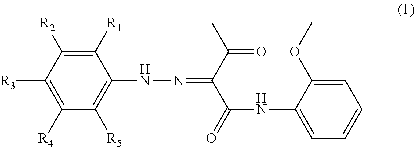

In the general formula (1), R₁ to R₅ each independently represent a hydrogen atom, a halogen atom, an alkyl group, an alkyl halide group, an alkoxy group, an acyl group, an aryl group, a nitro group, an alkoxycarbonyl group, an acyloxy group, a hydroxy group, an amino group, or a carboxy group, a sulfo group, a phosphoric acid group or a salt thereof. Alternatively, R₁ and R₂ can be bonded to each other to form an aromatic ring together with carbon atoms to which R₁ and R₂ are bonded, and at least one of R₁ to R₅ is a hydroxy group, an amino group, or a carboxy group, a sulfo group, a phosphoric acid group or a salt thereof.

Examples of the halogen atom in R₁ to R₅ include a chlorine atom, a bromine atom and a fluorine atom. The alkyl group in R₁ to R₅ is preferably an alkyl group having 1 to 8 carbon atoms, further preferably an alkyl group having 1 to 4 carbon atoms. Examples of the alkyl group include a methyl group, an ethyl group, an n-propyl group, an isopropyl group, a n-butyl group, a sec-butyl group, an isobutyl group, a tert-butyl group, a pentyl group, a hexyl group, a heptyl group, an octyl group and a 2-ethylhexyl group. Examples of the alkyl halide group in R₁ to R₅ include a group in which the above alkyl group is substituted with the above halogen atom.

Examples of the alkoxy group in R₁ to R₅ include a methoxy group, an ethoxy group, a propoxy group, a butoxy group and a phenoxy group.

Examples of the acyl group in R₁ to R₅ include a formyl group, an acetyl group, a propionyl group, a butyryl group, an isobutyryl group and a benzoyl group. Examples of the aryl group in R₁ to R₅ include a phenyl group, a tolyl group, a xylyl group and a naphthyl group.

Examples of the alkoxycarbonyl group in R₁ to R₅ include a methoxycarbonyl group, an ethoxycarbonyl group, a propoxycarbonyl group, a butoxycarbonyl group and a benzoyloxy group. Examples of the acyloxy group in R₁ to R₅ include an acetoxy group, a propanoyloxy group and a benzoyloxy group.

The carboxy group, the sulfo group and the phosphoric acid group in R₁ to R₅ may be each any of an acid type and a salt type, and in the case of a salt type, the salt type may be either in a state of being partially dissociated or in a state of being fully dissociated. In a case where the carboxy group, the sulfo group, or the phosphoric acid group is of the salt type, examples of the cation serving as the counterion include cations of alkali metals such as sodium and potassium, ammonium, as well as organic ammonium.

The above-mentioned alkyl group, alkoxy group, acyl group, aryl group, alkoxycarbonyl group and acyloxy group may each have a substituent. Examples of the substituent include the above-mentioned halogen atom, alkyl group, alkoxy group, acyl group and aryl group, as well as an amino group, a hydroxy group, a nitro group, a carboxy group, a sulfo group and a phosphoric acid group. In addition, R₁ and R₂ in the general formula (1) can be bonded to each other to form an aromatic ring together with carbon atoms to which R₁ and R₂ are bonded. In such a case, the aromatic ring formed together with carbon atoms to which R₁ and R₂ bonded to each other are bonded is preferably a benzene ring. In other words, a naphthalene ring is preferably formed together with an aromatic ring (benzene ring) having carbon atoms to which R₁ and R₂ are bonded in the general formula (1).

The pigment derivative (P2) has a solubilizing group. The solubilizing group is a functional group capable of contributing to water solubility of the pigment derivative (P2). When the pigment derivative (P2) has the solubilizing group, the pigment derivative (P2) is easily dissolved in an aqueous medium in the ink. Examples of the solubilizing group include a hydroxy group, an amino group, or a carboxy group, a sulfo group, a phosphoric acid group or a salt thereof. In other words, the pigment derivative (P2) has at least one functional group selected from the group consisting of a hydroxy group, an amino group, and a carboxy group, a sulfo group, a phosphoric acid group and a salt thereof. Among such solubilizing groups, a sulfo group (—SO₃H) or a salt thereof (—SO₃X) to be easily ionized in water is further preferred. Herein, X represents a counterion. When the pigment derivative (P2) has a sulfo group, the pigment derivative (P2) is easily adsorbed onto C.I. Pigment Yellow 74 in the ink, and the ability to disperse C.I. Pigment Yellow 74 is easily enhanced.

The solubilizing group may be substituted at any of the o-position, the m-position or the p-position at the diazo (diazo component-derived structure) side in the azo structure of the pigment derivative (P2). In particular, the solubilizing group is preferably substituted at the p-position at the diazo side.

The pigment derivative (P2) as the compound represented by the general formula (1) is sufficiently high in similarity of the chemical structure, to C.I. Pigment Yellow 74, and thus the pigment derivative (P2) is increased in interaction with C.I. Pigment Yellow 74 and is easily adsorbed onto the surface of C.I. Pigment Yellow 74.

The degree of solubility at 25° C. of the pigment derivative (P2) in water is preferably 100 mg/L or more and 10,000 mg/L or less. When the degree of solubility at 25° C. of the pigment derivative (P2) in water is 100 mg/L or more, a dissolved state in the ink is easily kept and precipitation hardly occurs. In this regard, when the degree of solubility at 25° C. of the pigment derivative (P2) in water is 10,000 mg/L or less, hydrophobic interaction with C.I. Pigment Yellow 74 occurs to enable adsorption to C.I. Pigment Yellow 74 to be achieved. The degree of solubility at 25° C. of the pigment derivative (P2) in water is more preferably 5,000 mg/L or less from the viewpoint that hydrophobic interaction with C.I. Pigment Yellow 74 is stronger and adsorption to C.I. Pigment Yellow 74 is easy.

Examples of the pigment derivative (P2) include a compound represented by any of the following chemical formulae (P2-1) to (P2-5). Hereinafter, the respective compounds represented by the following chemical formulae (P2-1) to (P2-5) may be designated as pigment derivatives P2-1 to P2-5 or simply designated as P2-1 to P2-5. Herein, the pigment derivative (P2) is not limited to P2-1 to P2-5 as long as the above mass ratio with respect to the pigment derivative (P2) is satisfied.

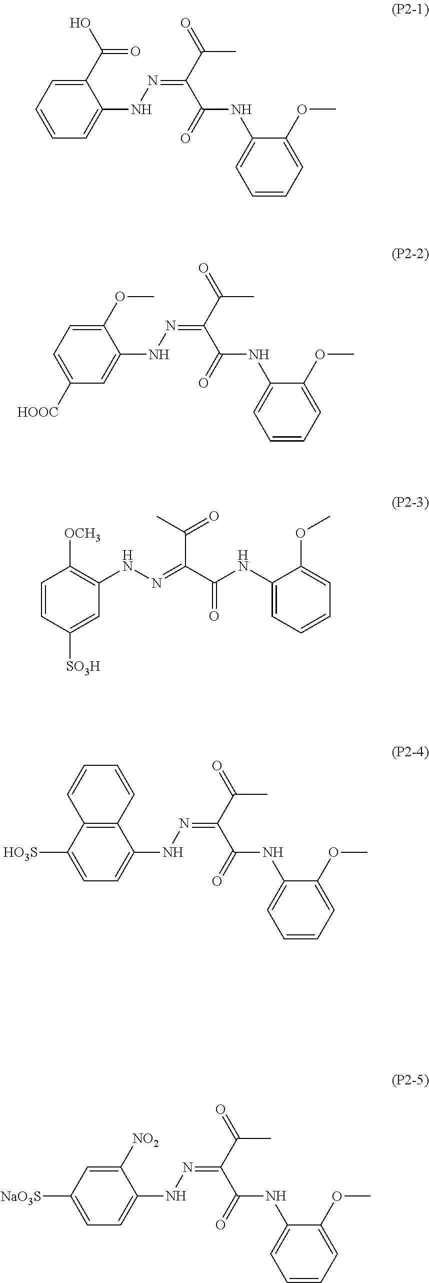

The pigment derivative (P2) is preferably a compound represented by the following general formula (2) or (3) from the viewpoint that the effect of inhibiting the generation of a foreign substance around a discharge port in the recording head is easily enhanced. A compound represented by the chemical formula (P2-5) is included in a compound represented by the following general formula (2), and a compound represented by the chemical formula (P2-4) is included in a compound represented by the following general formula (3).

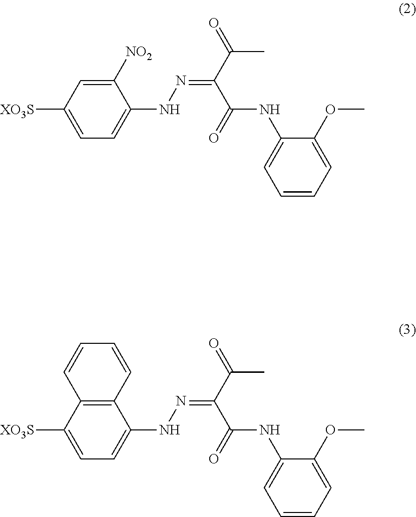

In general formulae (2) and (3), X represents a counter ion when —SO₃X is of the salt type and represents a hydrogen atom when —SO₃X is of the acid type. Cations serving as counter ions to —SO₃X in general formulae (2) and (3) include alkali metal cations such as sodium and potassium, ammonium, and organic ammonium.

### (XRD Peak of Pigment (Mixture of C.I. Pigment Yellow 74 and Pigment Derivative (P2)))

The width at half maximum of the diffraction peak located at diffraction angle 2θ=11.6±0.2° in an X-ray diffraction spectrum of a mixture of C.I. Pigment Yellow 74 and the pigment derivative (P2) as the compound represented by the general formula (1) in the ink is preferably 0.500 or less, more preferably 0.40° or less from the viewpoint of light resistance. Herein, “width at half maximum of the diffraction peak” means a peak width (angle) at a height (X-ray diffraction intensity) of one-half the height of each diffraction peak from the baseline in the powder X-ray diffraction spectrum.

C.I. Pigment Yellow 74, in which the width at half maximum of the diffraction peak falls within the above range, is high in crystallinity. Accordingly, light resistance of the pigment tends to be more enhanced.

Furthermore, the ratio of the diffraction peak intensity at diffraction angle 2θ=11.6±0.2° to the diffraction peak intensity at diffraction angle 2θ=26.8±0.2° is preferably 0.90 or more, still more preferably 1.00 or more from the viewpoint of fixation recoverability and suppression of a foreign substance discharged. In the case of C.I. Pigment Yellow 74, the diffraction peak located at diffraction angle 2θ=11.6 corresponds to the (011) plane of the crystal structure and the diffraction peak located at diffraction angle 2θ=26.8±0.2° corresponds to the (211) plane of the crystal structure. In a case where a crystal is grown in the (011) plane direction, it is indicated that the ratio of a molecule aligned along with the aromatic ring plane of C.I. Pigment Yellow 74 is increased. In such a case, the pigment derivative (P2) is easily adsorbed onto the 7G-7G plane of C.I. Pigment Yellow 74. In other words, when the above ratio of the diffraction peak intensities is satisfied, the pigment derivative (P2) can strongly interact with C.I. Pigment Yellow 74 (P1) by 7G-7G interaction and thus the pigment derivative (P2) hardly desorbs.

An XRD peak assigned to the mixture of C.I. Pigment Yellow 74 and the pigment derivative (P2) present in the ink can be measured by, for example, the following method. The ink is centrifuged by use of an ultracentrifuge. The supernatant is discarded, and the sediment is washed with water and then further washed with tetrahydrofuran (THf), and thus dried and solidified. The resulting dried and solidified product is subjected to measurement with a powder X-ray diffraction apparatus (trade name “RINT2000”, manufactured by Rigaku Corporation) according to the Japanese Industrial Standards JIS K0131 (X-ray diffraction analysis general rule).

The content (% by mass) of the pigment in the ink is preferably 1.0% by mass or more and 20.0% by mass or less, further preferably 2.0% by mass or more and 10.0% by mass or less based on the total mass of the ink. The above content of the pigment in the ink means the total content of C.I. Pigment Yellow 74 and the pigment derivative (P2) in the ink.

Examples of the dispersion system of the pigment include a resin dispersion pigment in which a resin (resin dispersant) is used as a dispersant and a self-dispersion pigment in which a hydrophilic group is bonded to a particle surface of the pigment. Examples can also include a resin-bonded pigment which includes a resin on a particle surface of the pigment and in which an organic group is chemically bonded, and a microcapsule pigment in which a particle surface of the pigment is covered with a resin or the like. In particular, not the resin-bonded pigment or the microcapsule pigment, but a resin dispersion pigment in which a resin as a dispersant is physically adsorbed onto a particle surface of the pigment is preferably used.

The ink may contain any other pigment (hereinafter, designated as “any other pigment”) than the above-mentioned C.I. Pigment Yellow 74 and pigment derivative (P2). In a case where such any other pigment is used, an azo-based pigment having a hue of yellow is preferably contained in the ink.

The content (% by mass) of such any other pigment in the ink is preferably 0.1% by mass or more and 5.0% by mass or less, further preferably 0.1% by mass or more and 1.0% by mass or less based on the total mass of the ink.

### (Resin)

The ink preferably further contains a resin. The content (% by mass) of the resin in the ink is preferably 0.1% by mass or more and 10.0% by mass or less, further preferably 0.3% by mass or more and 5.0% by mass or less based on the total mass of the ink.

The resin (i) can stabilize the dispersed state of the pigment, namely, can be contained as a resin dispersant of the pigment or an aid of the resin dispersant in the ink. In addition, the resin (ii) can be contained in the ink in order to enhance various properties of an image to be recorded. In particular, the ink preferably contains the resin dispersion pigment, and therefore the resin is preferably the resin dispersant. In other words, the ink preferably contains the resin dispersant in addition to the above pigment derivative (P2).

Examples of the form of the resin include a block copolymer, a random copolymer, a graft copolymer and any combination of such copolymers. The resin may be a soluble resin which can be dissolved in a liquid medium or may be a resin particle dispersed in a liquid medium. The resin particle is not required to include a color material.

Herein, “resin being soluble” means that the relevant resin, when neutralized by an alkali equivalent to the acid value, is present in the liquid medium, in the state of not forming a particle whose particle size can be measured by a dynamic light scattering method. Whether or not the resin is soluble can be determined according to the following method. First, a liquid (resin solid content: 10% by mass) containing a resin neutralized by an alkali (sodium hydroxide, potassium hydroxide or the like) in an amount corresponding to the acid value is prepared. Next, the liquid prepared is diluted 10-fold (on volume basis) with pure water to prepare a sample solution. In a case where a particle having a particle size is not observed in measurement of the particle size of the resin in the sample solution by a dynamic light scattering method, the resin can be determined to be soluble. The measurement conditions here can be set to, for example, SetZero: 30 seconds, the number of times of measurement: 3 times and the measurement time: 180 seconds. The particle size distribution measurement apparatus used here can be a particle size analyzer (for example, trade name “UPA-EX150”, manufactured by Nikkiso Co., Ltd.) by a dynamic light scattering method. Of course, the particle size distribution measurement apparatus, measurement conditions and the like used here are not limited to the above.

### [Amount of Adsorption of Resin]

The amount of adsorption of the resin adsorbed onto C.I. Pigment Yellow 74 in the aqueous ink is preferably 0.05% by mass or more and 30.0% by mass or less, more preferably 5.0% by mass or more and 30.0% by mass or less, further preferably 10.0% by mass or more and 30.0% by mass or less based on the total amount of C.I. Pigment Yellow 74 and the pigment derivative (P2) in the aqueous ink, from the viewpoint of fixation recoverability and suppression of generation of a foreign substance around a discharge port in the recording head. Hereinafter, the amount is sometimes expressed as “amount of adsorption of the resin”. Here, the amount of adsorption of the resin also includes the amount of the resin adsorbed onto C.I. Pigment Yellow 74 with the pigment derivative (P2) being interposed.

When the amount of adsorption of the resin to C.I. Pigment Yellow 74 is 0.05% by mass or more, dispersion stability of C.I. Pigment Yellow 74 is sufficiently kept and aggregation of C.I. Pigment Yellow 74 hardly occurs. Accordingly, the solubilizing group in the pigment derivative (P2) adsorbed onto a surface of C.I. Pigment Yellow 74 can be inhibited from being embedded inside between particles according to aggregation. Accordingly, even after storage of the ink for a long period, fixation recoverability and the effect of foreign substance suppression around a discharge port are not impaired. In addition, when the above amount of adsorption of the resin is 3.0% by mass or less, the solubilizing group in the pigment derivative (P2) is hardly embedded in the resin. In such a case, reductions in fixation recoverability and the effect of foreign substance suppression around a discharge port can be suppressed.

The amount of adsorption of the resin adsorbed onto C.I. Pigment Yellow 74 in the ink can be measured, for example, as follows. The ink is centrifuged by use of an ultracentrifuge at 57,000 rpm for 1 hour. The supernatant is discarded, the sediment is washed with water three times, and the resulting sediment is dried and solidified by use of a vacuum dryer. The dried and solidified product is completely dissolved in tetrahydrofuran (THF), and the concentrations of C.I. Pigment Yellow 74 and the pigment derivative (P2) are calculated by liquid chromatography mass analysis (LC-MS).

The difference from the solid content of the dried and solidified product can be defined as the mass of an adsorption resin and the amount of adsorption of the resin can be calculated.

Examples of the resin include an acrylic resin, and a urethane-based resin. Such resins can be used singly or in combinations of two or more kinds of such resins. In particular, an acrylic resin is preferred, and an acrylic resin having a hydrophilic unit and a hydrophobic unit is further preferred. In a case where the resin is used as the resin dispersant of the aqueous ink, an acrylic resin having a hydrophilic unit derived from (meth)acrylic acid and a hydrophobic unit derived from a monomer having an aliphatic group or an aromatic ring is preferred. Furthermore, an acrylic resin having a hydrophilic unit derived from (meth)acrylic acid and a hydrophobic unit derived from at least one monomer of styrene and α-methylstyrene can be preferably used as the resin dispersant. Such resin dispersants are suitable because interaction with the pigment particularly occurs.

The hydrophilic unit is a unit having a hydrophilic group. The hydrophilic unit can be formed by, for example, polymerizing a hydrophilic monomer having a hydrophilic group. Examples of the hydrophilic group include an anionic group such as a carboxy group, a hydroxy group and an ethylene oxide group. Examples of the hydrophilic monomer include acidic monomers each having a carboxy group, such as (meth)acrylic acid, itaconic acid, maleic acid and fumaric acid, anionic monomers such as anhydrides and salts of these acidic monomers, 2-hydroxyethyl (meth)acrylate and (poly)ethylene glycol (meth)acrylate. Examples of the cation constituting the salt of the acidic monomer include ions of lithium, sodium, potassium, ammonium and organic ammonium. The hydrophobic unit is a unit not having a hydrophilic group such as an anionic group, a hydroxy group and an ethylene oxide group. The hydrophobic unit can be formed by, for example, polymerizing a hydrophobic monomer not having the above hydrophilic group. Examples of the hydrophobic monomer include monomers each having an aromatic ring, such as styrene, α-methylstyrene and benzyl (meth)acrylate; and (meth)acrylate-based monomers such as methyl (meth)acrylate, ethyl (meth)acrylate, butyl (meth)acrylate and 2-ethylhexyl (meth)acrylate.

Furthermore, the resin preferably contains a copolymer having a unit derived from a monomer having an aromatic ring from the viewpoint of fixation resistance and discharge stability. The content (% by mass) of the unit derived from a monomer having an aromatic ring in the copolymer is preferably 60% by mass or more and 80% by mass or less, more preferably 60% by mass or more and 75% by mass or less based on the total mass of the copolymer.

When the above content of the unit derived from a monomer having an aromatic ring is 60% by mass or more, the number of aromatic rings serving as the points of adsorption to the pigment, present in the copolymer, is sufficient and dispersion stability of the pigment is sufficiently kept, thereby enabling the solubilizing group in the pigment derivative (P2) adsorbed onto a surface to be inhibited from being embedded inside between particles due to aggregation of C.I. Pigment Yellow 74. Accordingly, fixation recoverability and the effect of suppression of a foreign substance discharged are not impaired even after storage of the ink for a long period. In addition, when the above content of the unit derived from a monomer having an aromatic ring is 80% by mass or less, the molecular chain of the resin is hardly rigid and can be re-arranged in a solvent, and thus the resin hardly desorbs even if the ink is stored for a long period.

The weight average molecular weight of the resin is preferably 1,000 or more and 30,000 or less, further preferably 5,000 or more and 15,000 or less. Herein, the weight average molecular weight of the resin is a value in terms of polystyrene, as measured by gel permeation chromatography (GPC). The acid value of the resin is preferably 80 mgKOH/g or more and 250 mgKOH/g or less, further preferably 100 mgKOH/g or more and 200 mgKOH/g or less. Herein, the acid value of the resin, adopted here, can be a value measured with a potentiometric apparatus in which a potassium hydroxide-ethanol titration liquid is used.

### (Aqueous Medium)

The ink is an aqueous ink containing at least water as an aqueous medium. The ink can contain water or an aqueous medium being a mixed solvent of water and a water-soluble organic solvent. The water used here can be deionized water (ion-exchange water). The content (% by mass) of the water in the ink is preferably 50.0% by mass or more and 95.0% by mass or less, further preferably 50.0% by mass or more and 90.0% by mass or less based on the total mass of the ink.

The water-soluble organic solvent is not particularly limited as long as the solvent is water-soluble (preferably, a solvent dissoluble at any ratio in water at 25° C.). Specifically, monohydric or polyhydric alcohols, alkylene glycols, glycol ethers, nitrogen-containing polar compounds, sulfur-containing polar compounds and the like can be used. In particular, a water-soluble organic solvent containing 1,2-hexanediol having high solubility of the pigment is preferably used. The content (% by mass) of the water-soluble organic solvent in the ink is preferably 1.0% by mass or more and 46.0% by mass or less, further preferably 10.0% by mass or more and 40.0% by mass or less based on the total mass of the ink.

### (Other Additives)

The ink can contain, if necessary, various additives such as a surfactant, a pH adjuster, a preservative agent, a mildew-proofing agent, an oxidation inhibitor, a reduction inhibitor, a vaporization accelerator and a chelating agent. In particular, the ink preferably contains a surfactant. The content (% by mass) of the surfactant in the ink is preferably 0.1% by mass or more and 5.0% by mass or less, further preferably 0.1% by mass or more and 2.0% by mass or less based on the total mass of the ink.

Examples of the surfactant include an anionic surfactant, a cationic surfactant and a non-ionic surfactant.

### (Physical Properties of Ink)

The ink is an aqueous ink to be applied to an inkjet system. Accordingly, the values of physical properties are preferably appropriately controlled from the viewpoint of reliance. The surface tension of the ink at 25° C. is preferably 10 mN/m or more and 60 mN/m or less, further preferably 20 mN/m or more and 40 mN/m or less. The surface tension of the ink can be adjusted by appropriately determining the type and the content of the surfactant in the ink. In addition, the viscosity of the ink at 25° C. is preferably 1.0 mPa·s or more and 10.0 mPa·s or less. The pH of the ink at 25° C. is preferably 5.0 or more and 10.0 or less.

### <Method for Producing Ink>

Next, the method for producing the aqueous ink is described. Herein, the method for producing the aqueous ink of the present disclosure is not limited to any method shown below.

The method for producing the ink preferably includes the following first step and second step. Hereinafter, each step is described in detail.

[1]A first step of producing a pigment dispersion liquid from C.I. Pigment Yellow 74.

[2]A second step of mixing the pigment dispersion liquid, a pigment derivative (P2) and any other component necessary for an ink to be applied to an inkjet system, to prepare an aqueous ink.

### (First Step; Production of Pigment Dispersion Liquid)

The first step is production of a pigment dispersion liquid, and is a step which is for use in the production of an aqueous ink for inkjet and which is a step of dispersing C.I. Pigment Yellow 74 in a water-based liquid medium.

If necessary, an additive such as a pH adjuster may be used. In the first step, the pigment is dispersed by a treatment such as application of shear force necessary for a further desired particle size distribution. Examples of the dispersion system of the pigment include a resin dispersion pigment, a self-dispersion pigment, a resin-bonded pigment and a microcapsule pigment. In particular, a resin dispersion pigment is preferred. In the first step, known dispersion systems such as media dispersion using media (pulverizing medium) and media-less dispersion not using media can be used. Examples of a dispersion machine by media dispersion include a paint shaker, a bead mill, a sand mill, a ball mill and a roll mill.

Examples of a dispersion machine by media-less dispersion include an ultrasonic homogenizer and a high-pressure homogenizer. The first step may be performed by combining two or more of the above dispersion machines.

The temperature in the first step can be arbitrarily set. The temperature is preferably 0° C. or more and 100° C. or less in order to perform the first step in the water-based liquid medium. The time for the first step may be adjusted depending on the apparatus to be utilized, the concentration of the dispersion liquid and the like, and can be arbitrarily set as long as the pigment is not excessively dispersed. In addition, a preliminary dispersion step may also be performed in order to allow for easy dispersion by mixing a component containing the pigment and wetting the resulting mixture in the liquid medium.

In the preliminary dispersion step, the dispersion system and apparatus which are described as being usable in the first step as described above can be used.

### [Liquid Medium]

The first step is performed in a water-based liquid medium. The water-based liquid medium used here can be only water or an aqueous medium in which water serves as a main solvent and a protic or aprotic organic solvent is used in combination. The organic solvent used here is preferably a solvent to be admixed with or dissolved in water at any ratio. In particular, a uniform mixed solvent containing 50% by mass or more of water is preferably used. The water used here is preferably ion-exchange water or pure water.

The protic organic solvent is an organic solvent having a hydrogen atom (acidic hydrogen atom) bound to oxygen or nitrogen. In addition, the aprotic organic solvent is an organic solvent having no acidic hydrogen atom. Examples of the organic solvent include alcohols; alkylene glycols; polyalkylene glycols; glycol ethers; glycol ether esters; carboxylic amides; ketones; ketoalcohols; cyclic ethers; nitrogen-containing compounds; and sulfur-containing compounds. Such organic solvents can be used singly or in combinations of two or more kinds of such organic solvents.

### [Post-Treatment]

The pigment dispersion liquid produced is suitably subjected to a common post-treatment step such as purification, and then used for production of an ink for inkjet. In a case where only water is used without any organic solvent as the liquid medium, the pigment dispersion liquid obtained can be directly utilized for preparation of the ink or can also be washed and/or adjusted about the content of the pigment and then formed into a final pigment dispersion liquid. In a case where a liquid medium containing an organic solvent is utilized, the organic solvent may also be removed. The method for removing the organic solvent is, for example, a method in which, while the organic solvent is removed by pressure reduction by use of an evaporator or the like and/or heating, water is added to provide a dispersion liquid of the pigment in water. Furthermore, a method is also considered in which an operation including removing the organic solvent by ultrafiltration or the like and then adding water is repeated.

### (Second Step; Production of Ink)

The second step is a step of mixing the pigment dispersion liquid obtained in the first step, a pigment derivative (P2) and any other component. Examples of such any other component include water to be further added, a water-soluble organic solvent, a water-insoluble organic solvent, a resin and “any other additive” described above. The method for producing the ink may be performed by, for example, adding the pigment dispersion liquid, a pigment derivative (P2) and such any other component to an appropriate container and stirring the resultant. The pigment derivative (P2), which is in the state of a powder, in the form of an aqueous solution or in the form of being dissolved in such any other component in advance, may be added. Conditions, for example, the stirring speed, the temperature and the time can be appropriately set depending on desired condition. Any other known production step may also be combined.

### <Ink Cartridge>

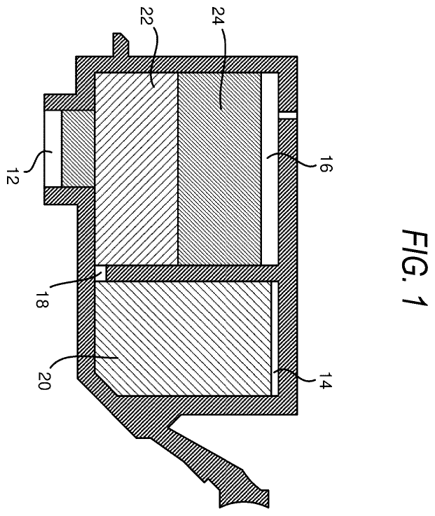

The ink cartridge of the present disclosure includes an ink and an ink storage portion that houses the ink. The ink housed in the ink storage portion is the aqueous ink of the present disclosure as described above. FIG. 1 is a cross-sectional view schematically illustrating one embodiment of the ink cartridge of the present disclosure. As illustrated in FIG. 1, an ink supply port 12 for supplying the ink to a recording head is provided at the bottom surface of the ink cartridge. The inside of the ink cartridge serves as an ink storage portion for housing the ink. The ink storage portion is configured from an ink storage room 14 and an absorber storage room 16, and these rooms communicate via a communication port 18. In addition, the absorber storage room 16 communicates with the ink supply port 12. A liquid ink 20 is housed in the ink storage room 14, and absorbers 22 and 24 in which the ink is retained in an impregnation state are housed in the absorber storage room 16. The ink storage portion may also be a form which has no ink storage room housing the liquid ink and which retains the total amount of the ink to be housed, by the absorbers. The ink storage portion may also be in a form which has no absorber and which houses the total amount of the ink in a liquid state.

Furthermore, the ink cartridge may also be an ink cartridge in a form which is configured so as to have the ink storage portion and a recording head.

### <Inkjet Recording Method>

The inkjet recording method of the present disclosure is a method including discharging the aqueous ink of the present disclosure, as described above, through an inkjet-type recording head to record an image in a recording medium. Examples of the system for discharging the ink include a system which applies mechanical energy to the ink and a system which applies heat energy to the ink. In the present disclosure, a system is particularly preferably adopted in which heat energy is applied to the ink to discharge the ink. A step of the inkjet recording method, other than use of the ink of the present disclosure, may be a known step.

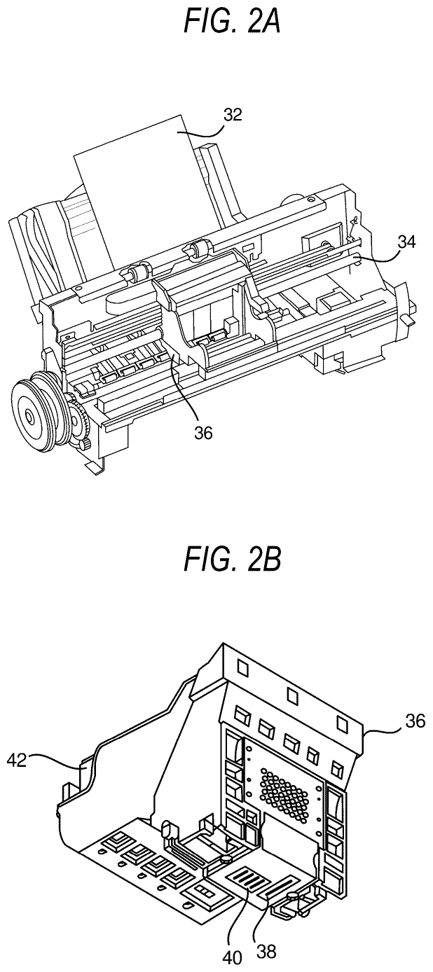

FIG. 2A and FIG. 2B are views schematically illustrating one example of an inkjet recording apparatus for use in the inkjet recording method of the present disclosure, FIG. 2A is a perspective view of a main portion of the inkjet recording apparatus and FIG. 2B is a perspective view of a head cartridge. A conveying unit (not illustrated) which conveys a recording medium 32 and a carriage shaft 34 are provided in the inkjet recording apparatus. A head cartridge 36 can be mounted on the carriage shaft 34. The head cartridge 36 includes recording heads 38 and 40 and is configured so that an ink cartridge 42 is set. While the head cartridge 36 is conveyed in a main scanning direction along with the carriage shaft 34, the ink (not illustrated) is discharged from the recording heads 38 and 40 toward the recording medium 32. The recording medium 32 is then conveyed in a vertical scanning direction by the conveying unit (not illustrated), thereby recording an image on the recording medium 32.

A recording medium used as a subject of recording by use of the ink of the present disclosure may be any recording medium. A recording medium having ink absorbency, for example, a recording medium having no coat layer, such as plain paper, or a recording medium having a coat layer, such as glossy paper or matte paper can be used. A recording medium having low ink absorbency or not having ink absorbency, such as actual printing paper, coated paper, a resin sheet or a resin film can be used. The ink of the present disclosure can be suitably used in an application in which the ink is directly applied to such a recording medium to record an image.

### EXAMPLES

Hereinafter, the present disclosure is described in further detail with reference to Examples and Comparative Examples, but the present disclosure is not limited by the following Examples at all without departing from the gist of the disclosure. Unless particularly noted, “part(s)” and “%” described with respect to the amount of a component are on a mass basis.

### <Analysis of Ink>

### (High-Performance Liquid Chromatography Mass Analysis)

Analysis by high-performance liquid chromatography mass analysis (HPLC/MS) was performed in the following conditions.

### [HPLC Analysis Conditions]

Column: silica gel column (trade name “SunFire C18 Column”, 2.1 mm×150
mm, manufactured by Waters Corporation)
Column temperature: 40° C.
Flow rate: 0.2 mL/min
Detector: diode array (PDA) detector
Detection range: 200 nm to 700 nm
Analysis time: 45 minutes
Gradient conditions of mobile phase: Table 1 below

TABLE 1
Gradient conditions of mobile phase

| | 0 to 5 | 5 to 24 | 24 to 31 | 31 to 45 |
|---|---|---|---|---|
| | minutes | minutes | minutes | minutes |
| A: Water | 85% | 85→45% | 45→0% | 0% |
| B: Methanol | 10% | 10→50% | 50→95% | 95% |
| C: 0.2 mol/L Aqueous | 5% | 5% | 5% | 5% |
| ammonium acetate solution | | | | |

### [Mass Analysis Conditions]

A mass spectrum was measured in the following conditions, with respect to a peak obtained in HPLC analysis performed in the above conditions. Measurement of m/z most strongly detected was made with respect to each of posi (ES+) and nega (ES−).
Ionization method: electrospray ionization method (ESI method)
Capillary voltage: 3.5 kV
Desolvation gas: 350° C.
Ion source temperature: 120° C.
Detector: posi (ES+); 40 V, 100 to 2000 amu/1.0 sec
nega (ES−); 40 V, 100 to 2000 amu/1.0 sec

### [Measurement of Mass Ratio of Each Pigment Component in Ink]

The ink was analyzed by HPLC analysis performed in the above conditions and each peak area of a peak assigned to each pigment component in the ink, obtained on a chromatogram at a detection wavelength of 254 nm, was measured. A standard DMSO solution for a calibration curve of each single pigment component, having a pigment concentration of 30 ppm, was also simultaneously analyzed, and the concentration calibration curve of such each pigment component, at a detection wavelength of 254 nm, was created.

Next, the pigment concentration in each pigment component in the ink was calculated from the resulting concentration calibration curve, and the mass ratio of such each pigment component in the ink was determined from the pigment concentration.

### (Measurement of Amount of Adsorption of Pigment Derivative (P2))

Measurement of the amount of adsorption of the pigment derivative (P2) adsorbed onto C.I. Pigment Yellow 74 in the ink was performed by the following method.

1) Six g of the ink was subjected to a centrifugation treatment (56,000 rpm for 30 minutes) and the resulting supernatant was allowed to pass through a syringe filter having a pore size of 0.45 μm, to provide a sample solution for non-adsorption component measurement.

2) A solution of DMSO:water=1:1 was added to the sediment remaining after removal of the supernatant from a liquid after the above centrifugation treatment so that the total amount was 6 g. After the sediment was lightly loosened by a spatula, ultrasonic cavitation (40 kHz for 30 seconds) was performed to obtain a suspension in which one portion of the pigment derivative (P2) adsorbed onto C.I. Pigment Yellow 74 was dissolved. The suspension was subjected to a centrifugation treatment (at a number of rotations of 56,000 rpm for 30 minutes) and the resulting supernatant was allowed to pass through a syringe filter having a pore size of 0.45 μm, to provide a sample for measurement of the adsorbing pigment derivative (P2). The supernatant was again removed, and the same operation was repeated ten times.

3) The total amount of the pigment derivative (P2) appearing in the supernatant by ten washing operations was defined as the amount (amount of adsorption) of the pigment derivative (P2) adsorbed onto C.I. Pigment Yellow 74. In addition, the difference obtained by subtracting the amounts of a non-adsorption component and an adsorption component from the total amount of the pigment derivative (P2) present in the ink was defined as the amount of the pigment derivative (P2) present inside the pigment of C.I. Pigment Yellow 74.

### Synthesis Example

### [Synthesis of C.I. Pigment Yellow 74]

### (Pigment Composition P1-1)

A suspension was prepared by adding 8.4 parts of 2-methoxy-4-nitroaniline to 63.0 parts of ion-exchange water and stirring the resultant. After 13.0 parts of 35% hydrochloric acid was added, stirring was performed for 1 hour and then the internal temperature was lowered to 0° C. or less by cooling in an ice-salt bath. Thereafter, an aqueous sodium nitrite solution prepared by adding 8.96 parts of ion-exchange water to 3.49 parts of sodium nitrite was added, and stirred for 1 hour in a state where the internal temperature was kept at 0° C. or less in the ice-salt bath, to form a diazonium salt. Excess nitrous acid was removed by adding 0.049 parts of sulfamic acid to the resulting diazonium salt solution, thereby preparing a diazo component solution.

A liquid was obtained by mixing, stirring and completely dissolving 10.2 parts of o-acetoacetanisidide, 5.12 parts of sodium hydroxide and 80.6 parts of ion-exchange water. The liquid obtained above was added to an aqueous solution in which 8.20 parts of acetic acid and 54.5 parts of ion-exchange water were mixed, and the resultant was stirred, thereby preparing a coupler component slurry.

The coupler component slurry was heated to 40° C. by a hot stirrer, and the diazo component solution was dropped over 30 minutes in a state where the internal temperature was kept at 40° C. Thereafter, stirring was performed at 40° C. for 30 minutes, thereafter the internal temperature was raised to 70° C. and stirring was performed for 20 minutes to complete the reaction, and a reaction liquid was filtrated to take out a reaction precipitate. The reaction precipitate was washed with a moderate amount of ion-exchange water three times, thereby obtaining a crude cake as a reaction product. The filter product obtained by filtration was dried, thereby obtaining pigment composition P1-1.

### (Pigment Composition P1-2)

A suspension of C.I. Pigment Yellow 74 was prepared by adding 500.0 parts of NNMP (N-methyl-2-pyrrolidone) to 10.0 parts of pigment composition P1-1 and stirring the resultant. The suspension of C.I. Pigment Yellow 74 was heated to 80° C. by a hot stirrer and stirred for 2 hours in a state where the internal temperature was kept at 80° C., and thereafter a liquid was filtrated to take out a precipitate. Such a reaction precipitate was washed with a moderate amount of ion-exchange water three times, thereby obtaining a crude cake as a reaction product. The filter product obtained by filtration was dried, thereby obtaining pigment composition P1-2.

### [Synthesis of Pigment Derivative]

### (Pigment Derivative P2-1)

Pigment derivative P2-1 was obtained by the same procedure as in production of pigment composition P1-1 except that 8.4 parts of 2-methoxy-4-nitroaniline was changed to 8.4 parts of 2-nitrobenzoic acid.

### (Pigment Derivative P2-2)

Pigment derivative P2-2 was obtained by the same procedure as in production of pigment composition P1-1 except that 8.4 parts of 2-methoxy-4-nitroaniline was changed to 8.4 parts of 3-amino-4-methoxybenzoic acid.

### (Pigment Derivative P2-3)

Pigment derivative P2-3 was obtained by the same procedure as in production of pigment composition P1-1 except that 8.4 parts of 2-methoxy-4-nitroaniline was changed to 10.2 parts of 2-methoxyaniline-5-sulfonic acid.

### (Pigment Derivative P2-4)

Pigment derivative P2-4 was obtained by the same procedure as in production of pigment composition P1-1 except that 8.4 parts of 2-methoxy-4-nitroaniline was changed to 11.2 parts of 4-amino-1-naphthalenesulfonic acid.

### (Pigment Derivative P2-5)

Pigment derivative P2-5 was obtained by the same procedure as in production of pigment composition P1-1 except that 8.4 parts of 2-methoxy-4-nitroaniline was changed to 12.0 parts of sodium 2-nitroaniline-4-sulfonate.

### (Pigment Derivative P2-6)

Pigment derivative P2-6 was obtained by the same procedure as in production of pigment composition P1-1 except that 8.4 parts of 2-methoxy-4-nitroaniline was changed to 12.0 parts of sodium 2-nitroaniline-4-sulfonate, and 10.2 parts of o-acetoacetanisidide was changed to 14.5 parts of potassium 4-(acetoacetylamino)benzenesulfonate.

The structures of pigment derivatives P2-1 to 6 synthesized are shown by the following general formula (4). R₂₀ to R₂₉ in the general formula (4) are each a substituent of the water-soluble yellow azo pigment derivative (P2), and are shown in Table 2 below. In Table 2, “Me” represents a methyl group, “OMe” represents a methoxy group, “COOH” represents an acid-type carboxy group (carboxy group), “SO₃Na” represents a sodium salt-type sulfo group and “SO₃K” represents a potassium salt-type sulfo group, respectively. In addition, “Np” in R₂₁ and R₂₂ in yellow azo pigment derivative P2-4 represents a naphthalene ring, and represents a structure in which a naphthalene ring is formed together with a benzene ring having carbon atoms to which R₂₁ and R₂₂ bonded to each other in the general formula (4) are bonded, on the ring.

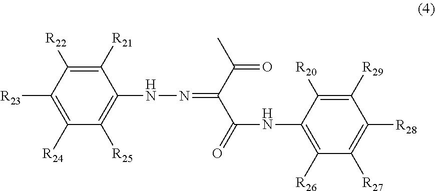

TABLE 2
Substituent of pigment derivative (P2) represented
by general formula (4)

| | R₂₁ | R₂₂ | R₂₃ | R₂₄ | R₂₅ | R₂₆ | R₂₇ | R₂₈ | R₂₉ | R₂₀ |
|---|---|---|---|---|---|---|---|---|---|---|
| P2-1 | COOH | H | H | H | H | H | H | H | H | OMe |
| P2-2 | OMe | H | H | CO₂H | H | H | H | H | H | OMe |
| P2-3 | OMe | H | H | SO₃H | H | H | H | H | H | OMe |
| P2-4 | Np | | SO₃H | H | H | H | H | H | H | OMe |
| P2-5 | NO₂ | H | SO₃Na | H | H | H | H | H | H | OMe |
| P2-6 | NO₂ | H | SO₃Na | H | H | H | H | SO₃K | H | H |

### (Mixed Coupling Compound 1)

A suspension was prepared by adding 42.3 parts of 2-methoxy-4-nitroaniline and 0.61 parts of sodium 2-nitroaniline-4-sulfonate to 337 parts of ion-exchange water and stirring the resultant.

After 69.0 parts of 35% hydrochloric acid was added and stirred for 1 hour, cooling was performed in an ice-salt bath until the internal temperature reached 0° C. or less. An aqueous sodium nitrite solution prepared by adding 44.0 parts of ion-exchange water to 18.5 parts of sodium nitrite was added, and stirred for 1 hour in a state where the internal temperature was kept at 0° C. or less in the ice-salt bath, to form a diazonium salt, thereby obtaining a diazonium salt solution. Excess nitrous acid was removed by adding 0.258 parts of sulfamic acid to the diazonium salt solution obtained, thereby preparing a mixed diazo component solution.

A liquid was obtained by mixing, stirring and completely dissolving 53.8 parts of o-acetoacetanisidide, 27.1 parts of sodium hydroxide and 427 parts of ion-exchange water. The above liquid was added to an aqueous solution in which 43.4 parts of acetic acid and 289 parts of ion-exchange water were mixed, and the resultant was stirred, thereby preparing a coupler component slurry.

The coupler component slurry was heated to 40° C. by use of an oil bath, and the mixed diazo component solution was dropped over 45 minutes in a state where the internal temperature was kept at 40° C. After stirring was performed at 40° C. for 30 minutes, the internal temperature was raised to 70° C. and stirring was performed for 20 minutes to complete the reaction. A reaction precipitate taken out by air-cooling a reaction liquid to room temperature and filtrating the reaction liquid was washed with 1,500 parts of ion-exchange water three times, thereby obtaining a cake-like crude reaction product. A slurry obtained by adding 5,000 parts of ion-exchange water to the crude reaction product was stirred for 1 hour, and washed and filtrated. After 2,500 parts of ethanol was added to a filter product (residue) to perform washing in the same manner, the resulting filter product was dried, thereby obtaining mixed coupling compound 1 containing PY74 and yellow azo pigment derivative P2-1. The analysis results of mixed coupling compound 1 by HPLC/MS are shown below.

### (Mass Ratio)

C.I. Pigment Yellow 74: 99.02%
Pigment derivative P2-5: 0.98%

### (Mixed Coupling Compound 2)

Mixed coupling compound 2 was obtained by the same procedure as in production of mixed coupling compound 1 except that the amount of sodium 2-nitroaniline-4-sulfonate was changed from 0.61 parts to 1.83 parts. The analysis results of mixed coupling compound 2 by HPLC/MS are shown below.

### (Mass Ratio)

C.I. Pigment Yellow 74: 96.98%
Pigment derivative P2-5: 3.02%

### (Mixed Coupling Compound 3)

Mixed coupling compound 3 was synthesized with reference to Japanese Patent Laid-Open No. 2008-231178. Mixed coupling compound 3 containing PY74 and pigment derivative P2-7 was obtained by the same procedure as in production of mixed coupling compound 1 except that 0.61 parts of sodium 2-nitroaniline-4-sulfonate was changed to 5.7 parts of a compound represented by the following formula (A) and the amount of 2-methoxy-4-nitroaniline was changed from 42.3 parts to 41.0 parts. The structure of pigment derivative P2-7 synthesized is represented by the following formula (B). The analysis results of mixed coupling compound 3 by HPLC/MS are shown below.

### (Mass Ratio)

C.I. Pigment Yellow 74: 95.81%
Pigment derivative P2-7: 4.19%

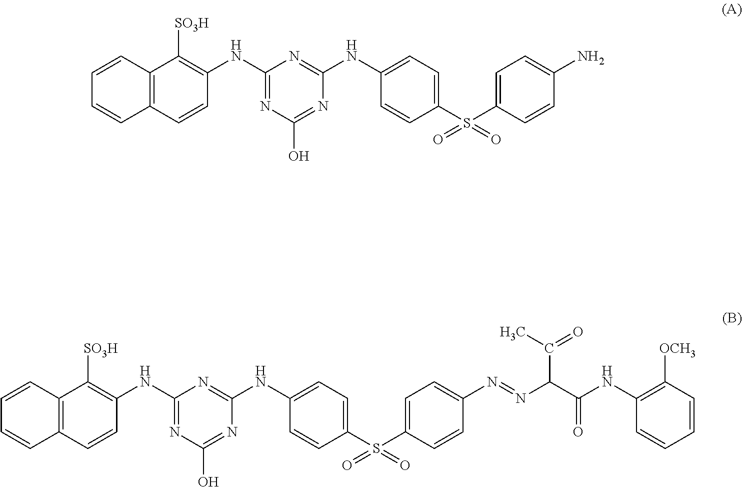 [SMILES: Nc1ccc(S(=O)(=O)c2ccc(Nc3nc(O)nc(Nc4ccc5ccccc5c4S(=O)(=O)O)n3)cc2)cc1 ; COc1ccccc1NC(=O)C(/N=N/c1ccc(S(=O)(=O)c2ccc(Nc3nc(O)nc(Nc4ccc5ccccc5c4S(=O)(=O)O)n3)cc2)cc1)C(C)=O]

### <Synthesis of Resin>

### (Resin Solution 1)

After 200.0 parts of isopropanol was placed in a flask equipped with a stirring apparatus, a nitrogen introduction tube, a reflux cooling apparatus and a thermometer, the temperature was raised to 85° C. with stirring under a nitrogen atmosphere. A mixture of 60.0 parts of styrene, 20.0 parts of n-butyl acrylate, 20.0 parts of acrylic acid and 5.0 parts of a polymerization initiator was dropped into the flask over 2 hours while the system was kept at 85° C.

The polymerization initiator used here was a solution in which 5.0 parts of trade name “Perkadox L-W75(LS)” (dibenzoyl peroxide, manufactured by Kayaku Akzo Co., Ltd., purity 75%) was dissolved in 10.0 parts of isopropanol. The system was kept at 85° C. and stirring was performed for 4 hours, and thus resin 1 was synthesized. After potassium hydroxide in an amount of 0.9-fold (molar basis) relative to the acid value of the resin and a moderate amount of ion-exchange water were added, isopropanol was removed under reduced pressure, thereby obtaining resin solution 1 in which the content of the resin 1 was 17.6%.

### (Resin Solution 2)

The amount of styrene was changed from 60.0 parts to 50.0 parts and the amount of n-butyl acrylate was changed from 20.0 parts to 30.0 parts. Resin 2 was synthesized, and resin solution 2 in which the content of the resin 2 was 17.8% was obtained by the same procedure as in production of resin solution 1 except for the above changes.

### (Resin Solution 3)

The amount of styrene was changed from 60.0 parts to 85.0 parts, the amount of n-butyl acrylate was changed from 20.0 parts to 0 parts and the amount of acrylic acid was changed from 20.0 parts to 15.0 parts. Resin 3 was synthesized, and resin solution 3 in which the content of the resin 3 was 17.5% was obtained by the same procedure as in production of resin solution 1 except for the above changes.

### (Resin Solution 4)

The amount of styrene was changed from 60.0 parts to 80.0 parts, the amount of n-butyl acrylate was changed from 20.0 parts to 5.0 parts and the amount of acrylic acid was changed from 20.0 parts to 15.0 parts. Resin 4 was synthesized, and resin solution 4 in which the content of the resin 4 was 17.5% was obtained by the same procedure as in production of resin solution 1 except for the above changes.

### (Resin Solution 5)

A resin solution was prepared with reference to Japanese Patent Laid-Open No. 2008-231178. Specifically, 10 parts of methyl ethyl ketone, 0.02 parts of a polymerization chain transfer agent (2-mercaptoethanol) and each monomer (expressed as part(s)) shown in Table 3 were placed and mixed in a reaction vessel, and sufficiently purged with nitrogen gas, thereby obtaining an initially charged monomer solution.

On the other hand, each monomer (expressed as part(s)) shown in Table 3 was charged into a dropping funnel, and then 0.08 parts of the polymerization chain transfer agent, 80 parts of methyl ethyl ketone and 1.0 part of a polymerization initiator (2,2′-azobis(2,4-dimethylvaleronitrile)) were placed and mixed, and sufficiently purged with nitrogen gas, thereby obtaining a dropped monomer solution.

The initially charged monomer solution in the reaction vessel was heated to 75° C. with stirring under a nitrogen atmosphere, and the dropped monomer solution in the dropping funnel was gradually dropped into the reaction vessel over 3 hours. After completion of the dropping, the liquid temperature of the mixed solution was kept at 75° C. for 2 hours, and thereafter a solution in which 0.6 parts of the polymerization initiator was dissolved in 10 parts of methyl ethyl ketone was added to the mixed solution and furthermore aged at 75° C. for 3 hours and at 85° C. for 2 hours, thereby obtaining resin solution 5 containing resin 5.

TABLE 3
Materials of resin solution 5

| | | (part(s)) |
|---|---|---|
| Monomer solution | Methacrylic acid | 2.8 |
| initially charged | Styrene macromer *1 | 3 |
| | Stearyl methacrylate | 1 |
| | Styrene | 8.2 |
| | Octoxy polyethylene | 5 |
| | glycol monomethacrylate *2 | |
| | Methyl ethyl ketone | 10 |
| | 2-Mercaptoethanol | 0.02 |
| Monomer solution | Methacrylic acid | 11.2 |
| dropped | Styrene macromer *1 | 12 |
| | Stearyl methacrylate | 4 |
| | Styrene | 32.8 |
| | Octoxy polyethylene | 20 |
| | glycol monomethacrylate *2 | |
| | Methyl ethyl ketone | 80 |
| | 2-Mercaptoethanol | 0.08 |
| | 2,2′-Azobis(2,4- | 1 |
| | dimethylvaleronitrile) | |

*1: manufactured by Toagosei Co., Ltd., trade name AS-6S, number average molecular weight: 6000
*2: Average addition molar number of ethylene oxide = 4, terminal: 2-ethylhexyl group

Table 4 shows the mass ratio of the unit derived from a monomer having an aromatic ring in the resin in each of resin solutions 1 to 5 obtained.

TABLE 4
Mass ratio of monomer unit in resin

| | Mass ratio of unit derived from |
|---|---|
| | monomer having aromatic ring |
| Resin solution 1 | 60 |
| Resin solution 2 | 50 |
| Resin solution 3 | 85 |
| Resin solution 4 | 80 |
| Resin solution 5 | 56 |

### <Preparation of Pigment Dispersion Liquid>

### (Pigment Dispersion Liquid D1)

A mixture was obtained by mixing 20.0 parts of pigment composition P1-1, 22.7 parts of resin solution 1 obtained above and 57.3 parts of ion-exchange water. The mixture was dispersion-treated at a treatment pressure of 200 MPa by use of a homogenizer (trade name “STAR BURST”, manufactured by SUGINO MACHINE LIMITED). Thereafter, a moderate amount of ion-exchange water was added to obtain pigment dispersion liquid D1 in which the content of the pigment was 15.0% and the content of the resin was 3.0%.

### (Pigment Dispersion Liquid D2)

Pigment dispersion liquid D2 in which the content of the pigment was 15.0% and the content of the resin was 0.75% was obtained by the same procedure as in preparation of pigment dispersion liquid D1 except that pigment composition P1-1 was changed to pigment composition P1-2, 22.7 parts of resin solution 1 was changed to 5.6 parts of resin solution 2 and the amount (57.3 parts) of ion-exchange water was changed to 74.4 parts.

### (Pigment Dispersion Liquid D3)

Pigment dispersion liquid D3 in which the content of the pigment was 15.0% and the content of the resin was 9.0% was obtained by the same procedure as in preparation of pigment dispersion liquid D1 except that pigment composition P1-1 was changed to pigment composition P1-2, 22.7 parts of resin solution 1 was changed to 67.4 parts of resin solution 2 and the amount (57.3 parts) of ion-exchange water was changed to 12.6 parts.

### (Pigment Dispersion Liquid D4)

Pigment dispersion liquid D4 in which the content of the pigment was 15.0% and the content of the resin was 3.0% was obtained by the same procedure as in preparation of pigment dispersion liquid D1 except that pigment composition P1-1 was changed to pigment composition P1-2.

### (Pigment Dispersion Liquid D5)

Pigment dispersion liquid D5 in which the content of the pigment was 15.0% and the content of the resin was 3.0% was obtained by the same procedure as in preparation of pigment dispersion liquid D1 except that pigment composition P1-1 was changed to pigment composition P1-2, 22.7 parts of resin solution 1 was changed to 22.9 parts of resin solution 3 and the amount (57.3 parts) of ion-exchange water was changed to 57.1 parts.

### (Pigment Dispersion Liquid D6)

Pigment dispersion liquid D6 in which the content of the pigment was 15.0% and the content of the resin was 3.0% was obtained by the same procedure as in preparation of pigment dispersion liquid D1 except that 22.7 parts of resin solution 1 was changed to 22.5 parts of resin solution 2 and the amount (57.3 parts) of ion-exchange water was changed to 57.5 parts.

### (Pigment Dispersion Liquid D7)

Pigment dispersion liquid D7 in which the content of the pigment was 15.0% and the content of the resin was 3.0% was obtained by the same procedure as in preparation of pigment dispersion liquid D1 except that pigment composition P1-1 was changed to pigment composition P1-2, 22.7 parts of resin solution 1 was changed to 22.5 parts of resin solution 2 and the amount (57.3 parts) of ion-exchange water was changed to 57.5 parts.

### (Pigment Dispersion Liquid D8)

Pigment dispersion liquid D8 in which the content of the pigment was 15.0% and the content of the resin was 3.0% was obtained by the same procedure as in preparation of pigment dispersion liquid D1 except that pigment composition P1-1 was changed to pigment composition P1-2, 22.7 parts of resin solution 1 was changed to 22.9 parts of resin solution 4 and the amount (57.3 parts) of ion-exchange water was changed to 57.1 parts.

### (Pigment Dispersion Liquid D9)

Pigment dispersion liquid D9 in which the content of the pigment was 15.0% and the content of the resin was 1.5% was obtained by the same procedure as in preparation of pigment dispersion liquid D1 except that pigment composition P1-1 was changed to pigment composition P1-2, 22.7 parts of resin solution 1 was changed to 11.2 parts of resin solution 2 and the amount (57.3 parts) of ion-exchange water was changed to 68.8 parts.

### (Pigment Dispersion Liquid D10)

Pigment dispersion liquid D10 in which the content of the pigment was 15.0% and the content of the resin was 7.5% was obtained by the same procedure as in preparation of pigment dispersion liquid D1 except that pigment composition P1-1 was changed to pigment composition P1-2, 22.7 parts of resin solution 1 was changed to 56.2 parts of resin solution 2 and the amount (57.3 parts) of ion-exchange water was changed to 23.8 parts.

### (Pigment Dispersion Liquid D11)

Pigment dispersion liquid D11 in which the content of the pigment was 15.2% and the content of the resin was 3.0% was obtained by the same procedure as in preparation of pigment dispersion liquid D1 except that 20.0 parts of pigment composition P1-1 was changed to 20.2 parts of mixed coupling compound 1 and 22.7 parts of resin solution 1 was changed to 22.5 parts of resin solution 2.

### (Pigment Dispersion Liquid D12)

Pigment dispersion liquid D12 in which the content of the pigment was 15.5% and the content of the resin was 3.0% was obtained by the same procedure as in preparation of pigment dispersion liquid D1 except that 20.0 parts of pigment composition P1-1 was changed to 20.6 parts of mixed coupling compound 2, 22.7 parts of resin solution 1 was changed to 22.5 parts of resin solution 2 and the amount (57.3 parts) of ion-exchange water was changed to 56.9 parts.

### (Pigment Dispersion Liquid D13)

Pigment dispersion liquid D13 was prepared with reference to Japanese Patent Laid-Open No. 2008-231178. A mixture was obtained by dissolving 40.0 parts of a resin obtained by drying resin solution 4 under reduced pressure, in 72.0 parts of methyl ethyl ketone, neutralizing a salt generation group by a mixture of 200.0 parts of ion-exchange water and 65% of the resulting dissolved product added relative to the acid value of a neutralizing agent (aqueous 5N sodium hydroxide solution) and further adding 62.4 parts of mixed coupling compound 3. The mixture obtained was dispersion-treated at a treatment pressure of 200 MPa by use of a homogenizer (trade name “STAR BURST”, manufactured by SUGINO MACHINE LIMITED). Methyl ethyl ketone was removed from the resulting dispersion body by use of an evaporator at 60° C. under reduced pressure. Thereafter, a moderate amount of ion-exchange water was added to obtain pigment dispersion liquid D10 in which the content of the pigment was 15.6% and the content of the resin was 10.0%.

The types and the concentrations (%) of the pigments and the resins in the pigment dispersion liquids obtained are shown in Table 5.

TABLE 5
Preparation of pigment dispersion liquid

| Pigment | Pigment | | Resin | |
|---|---|---|---|---|
| dispersion | | Concentration | | Concentration |
| liquid | Type | (%) | Type | (%) |
| D1 | P1-1 | 15.0% | 1 | 3.0% |
| D2 | P1-2 | 15.0% | 2 | 0.75% |
| D3 | P1-2 | 15.0% | 2 | 9.0% |
| D4 | P1-2 | 15.0% | 1 | 3.0% |
| D5 | P1-2 | 15.0% | 3 | 3.0% |
| D6 | P1-1 | 15.0% | 2 | 3.0% |
| D7 | P1-2 | 15.0% | 2 | 3.0% |
| D8 | P1-2 | 15.0% | 4 | 3.0% |
| D9 | P1-2 | 15.0% | 2 | 1.5% |
| D10 | P1-2 | 15.0% | 2 | 7.5% |
| D11 | Mixed coupling 1 | 15.2% | 2 | 3.0% |
| D12 | Mixed coupling 2 | 15.5% | 2 | 3.0% |
| D13 | Mixed coupling 3 | 15.6% | 5 | 10.0% |

### <Preparation of Ink>

Each component (unit: part(s)) shown in the middle rows of Table 6 (Tables 6-1 to 6-4) was mixed and sufficiently stirred, and thereafter filtrated under pressure by a microfilter having a pore size of 2.5 μm (manufactured by FUJIFILM Corporation) to prepare each ink. The pigment dispersion liquid and the yellow azo pigment derivative used here were of the types shown in the top rows of Table 3. In Table 6, “PEG1K” is polyethylene glycol having a number average molecular weight of 1,000 and “ACETYLENOL E100” is the trade name of a non-ionic surfactant manufactured by Kawaken Fine Chemicals Co., Ltd.

### <Percentage of Adsorption of Pigment Derivative (P2)>

The results of measurement of the amount of adsorption of the pigment derivative (P2) adsorbed onto C.I. Pigment Yellow 74 with respect to each ink by a method shown in “Measurement of amount of adsorption of pigment derivative (P2)” described above are shown in the column “Detail of P2” in the bottom rows of Table 6. In the column, “P2-A (mg/L)” represents the amount of the pigment derivative (P2) present as a free form (released) in the ink. “P2-B (mg/L)” represents the amount of the pigment derivative (P2) adsorbed onto C.I. Pigment Yellow 74 in the ink. “P2-C (mg/L)” represents the amount of the pigment derivative (P2) present inside C.I. Pigment Yellow 74 in the ink. In the bottom row of Table 6, “P2/P1(%)” represents the mass ratio (%) of the pigment derivative (P2) to C.I. Pigment Yellow 74 (P1) present in the ink. “(P2-B)/P1(%)” represents the mass ratio (%) of the pigment derivative (P2) adsorbed onto C.I. Pigment Yellow 74 (P1) to C.I. Pigment Yellow 74 (P1) present in the ink. “(P2-C)/P1(%)” represents the mass ratio (%) of the pigment derivative (P2) present inside C.I. Pigment Yellow 74 (P1) to C.I. Pigment Yellow 74 (P1) present in the ink.

### <Width at Half Maximum of Peak and Peak Intensity Ratio in X-Ray Diffraction Spectrum of Pigment in Ink>

The width at half maximum of a peak assigned to the pigment (mixture of C.I. Pigment Yellow 74 (P1) and pigment derivatives (P2-B) and (P2-C)) and the peak intensity ratio were measured as follows.

Six g of the ink was subjected to centrifugation treatment (at a number of rotations of 56,000 rpm for 30 minutes), the supernatant was removed, and the sediment was washed with water three times and furthermore washed with tetrahydrofuran, and thus dried and solidified. The resulting dried and solidified product was ground with a mortar and measurement with a powder X-ray diffraction apparatus (trade name “RINT2000”, manufactured by Rigaku Corporation) was performed according to Japanese Industrial Standards JIS K0131 (X-ray diffraction analysis general rule). The width at half maximum of a peak at a diffraction angle of 2θ=11.6±0.2°, and the ratio of the diffraction peak intensity at a diffraction angle of 2θ=11.6±0.2° to the diffraction peak intensity at a diffraction angle of 2θ=26.8±0.2° (peak intensity ratio), are shown in the lower part of Table 6.

<Amount of Resin Adsorbed onto Pigment Based on Total Amount of Pigment in Ink>

The amount of the resin adsorbed onto the pigment (C.I. Pigment Yellow 74 (P1) and pigment derivative (P2-B) adsorbed onto P1) (the amount of adsorption of the resin) was measured as follows.

Six g of the ink was subjected to a centrifugation treatment (at a number of rotations of 57,000 rpm for 1 hour), the supernatant was removed, the sediment was washed with water three times, and thereafter the resulting sediment was dried and solidified by use of a vacuum dryer. The dried and solidified product was completely dissolved in THF, the pigment concentration was calculated by LC-MS, and the difference from the solid content of the dried and solidified product was defined as the mass of the adsorption resin. The ratio (%) of the total mass of the resin adsorbed onto the pigment (C.I. Pigment Yellow 74 (P1) and pigment derivative (P2)) in the ink, to the total amount of the pigment, was calculated. The results are shown in the column “Adsorption resin/(P1+P2-B,C) (%)” in the bottom row of Table 6.

<Ratio of Mass of Unit Derived from Monomer Having Aromatic Ring to Amount of Total Resin in Ink>

The ratio (%) of the mass of the unit derived from a monomer having an aromatic ring to the amount of the total resin in the ink is shown in the column “Unit derived from monomer having aromatic ring (%)” in the bottom row of Table 6.

TABLE 6
Compositional ratio, properties of ink

| | | Examples | | | | | | |
|---|---|---|---|---|---|---|---|---|
| | | 1 | 2 | 3 | 4 | 5 | 6 | 7 |
| Type of pigment dispersion liquid | | D1 | D1 | D1 | D1 | D1 | D2 | D3 |
| Type of pigment derivative | | P2-1 | P2-2 | P2-3 | P2-4 | P2-5 | P2-5 | P2-5 |
| Formulation | Pigment dispersion | 30.0 | 30.0 | 30.0 | 30.0 | 30.0 | 30.0 | 30.0 |
| of ink | liquid | | | | | | | |
| components | Pigment derivative | 0.045 | 0.045 | 0.045 | 0.045 | 0.045 | 0.045 | 0.045 |
| (part(s)) | Glycerin | 8.0 | 8.0 | 8.0 | 8.0 | 8.0 | 8.0 | 8.0 |
| | 1,2-Hexanediol | 3.0 | 3.0 | 3.0 | 3.0 | 3.0 | 3.0 | 3.0 |
| | Triethylene glycol | 1.5 | 1.5 | 1.5 | 1.5 | 1.5 | 1.5 | 1.5 |
| | PEG1K | 3.0 | 3.0 | 3.0 | 3.0 | 3.0 | 3.0 | 3.0 |
| | ACETYLENOL E100 | 1.0 | 1.0 | 1.0 | 1.0 | 1.0 | 1.0 | 1.0 |
| | Water | 53.5 | 53.5 | 53.5 | 53.5 | 53.5 | 53.5 | 53.5 |
| Content (%) of PY74(P1) in ink | | 4.5 | 4.5 | 4.5 | 4.5 | 4.5 | 4.5 | 4.5 |
| Content (%) of pigment | | 0.045 | 0.045 | 0.045 | 0.045 | 0.045 | 0.045 | 0.045 |
| derivative (P2) in ink | | | | | | | | |
| Detail of P2 | P2-A(mg/L) | 244 | 284 | 233 | 96 | 55 | 244 | 244 |
| | P2-B(mg/L) | 162 | 112 | 117 | 224 | 243 | 162 | 162 |
| | P2-C(mg/L) | 44 | 54 | 100 | 130 | 152 | 44 | 44 |

| | | | | | | | |
|---|---|---|---|---|---|---|---|
| P2/P1(%) | 1.00 | 1.00 | 1.00 | 1.00 | 1.00 | 1.00 | 1.00 |
| (P2-B)/P1(%) | 0.36 | 0.25 | 0.26 | 0.50 | 0.54 | 0.36 | 0.36 |
| (P2-C)/P1(%) | 0.10 | 0.12 | 0.22 | 0.29 | 0.35 | 0.10 | 0.10 |
| Width at half maximum | 0.52 | 0.53 | 0.52 | 0.52 | 0.52 | 0.29 | 0.29 |
| Peak intensity ratio | 0.84 | 0.84 | 0.84 | 0.84 | 0.84 | 0.97 | 0.97 |
| Adsorption resin/ | 4% | 4% | 3% | 4% | 2% | 1% | 40% |
| (P1 + P2-B, C) (%) | | | | | | | |
| Unit derived from monomer | 60 | 60 | 60 | 60 | 60 | 50 | 50 |
| having aromatic ring (%) | | | | | | | |

| | | Examples | | | | | | | |
|---|---|---|---|---|---|---|---|---|---|
| | | 8 | 9 | 10 | 11 | 12 | 13 | 14 | 15 |
| Type of pigment dispersion liquid | | D4 | D5 | D6 | D7 | D7 | D7 | D7 | D8 |
| Type of pigment derivative | | P2-5 | P2-5 | P2-5 | P2-1 | P2-5 | P2-5 | P2-4 | P2-5 |
| Formulation | Pigment dispersion | 30.0 | 30.0 | 30.0 | 30.0 | 30.0 | 30.0 | 30.0 | 30.0 |
| of ink | liquid | | | | | | | | |
| components | Pigment derivative | 0.045 | 0.045 | 0.045 | 0.045 | 0.135 | 0.045 | 0.045 | 0.045 |
| (part(s)) | Glycerin | 8.0 | 8.0 | 8.0 | 8.0 | 8.0 | 8.0 | 8.0 | 8.0 |
| | 1,2-Hexanediol | 3.0 | 3.0 | 3.0 | 3.0 | 3.0 | 3.0 | 3.0 | 3.0 |
| | Triethylene glycol | 1.5 | 1.5 | 1.5 | 1.5 | 1.5 | 1.5 | 1.5 | 1.5 |
| | PEG1K | 3.0 | 3.0 | 3.0 | 3.0 | 3.0 | 3.0 | 3.0 | 3.0 |
| | ACETYLENOL E100 | 1.0 | 1.0 | 1.0 | 1.0 | 1.0 | 1.0 | 1.0 | 1.0 |
| | Water | 53.5 | 53.5 | 53.5 | 53.5 | 53.4 | 53.5 | 53.5 | 53.5 |
| Content (%) of PY74(P1) in ink | | 4.5 | 4.5 | 4.5 | 4.5 | 4.5 | 4.5 | 4.5 | 4.5 |
| Content (%) of pigment | | 0.045 | 0.045 | 0.045 | 0.045 | 0.135 | 0.045 | 0.045 | 0.045 |
| derivative (P2) in ink | | | | | | | | | |
| Detail of P2 | P2-A(mg/L) | 244 | 244 | 244 | 244 | 244 | 50 | 56 | 62 |
| | P2-B(mg/L) | 162 | 162 | 162 | 162 | 162 | 243 | 240 | 245 |
| | P2-C(mg/L) | 44 | 44 | 44 | 44 | 44 | 157 | 154 | 143 |

| | | | | | | | | |
|---|---|---|---|---|---|---|---|---|
| P2/P1(%) | 1.00 | 1.00 | 1.00 | 1.00 | 3.00 | 1.00 | 1.00 | 1.00 |
| (P2-B)/P1(%) | 0.36 | 0.36 | 0.36 | 0.36 | 0.36 | 0.54 | 0.53 | 0.54 |
| (P2-C)/P1(%) | 0.10 | 0.10 | 0.10 | 0.10 | 0.10 | 0.35 | 0.34 | 0.32 |
| Width at half maximum | 0.29 | 0.29 | 0.52 | 0.29 | 0.29 | 0.29 | 0.29 | 0.29 |
| Peak intensity ratio | 0.97 | 0.97 | 0.84 | 0.97 | 0.97 | 0.97 | 0.97 | 0.97 |
| Adsorption resin/ | 15% | 12% | 9% | 12% | 13% | 11% | 12% | 13% |
| (P1 + P2-B, C) (%) | | | | | | | | |
| Unit derived from monomer | 60 | 85 | 50 | 50 | 50 | 50 | 50 | 80 |
| having aromatic ring (%) | | | | | | | | |

| | | | Examples | | |
|---|---|---|---|---|---|
| | | | 16 | 17 | 18 |
| Type of pigment dispersion liquid | | | D9 | D10 | D7 |
| Type of pigment derivative | | | P2-5 | P2-5 | P2-5 |
| | Formulation | Pigment dispersion | 30.0 | 30.0 | 30.0 |
| | of ink | liquid | | | |
| | components | Pigment derivative | 0.045 | 0.045 | 0.090 |
| | (part(s)) | Glycerin | 8.0 | 8.0 | 8.0 |
| | | 1,2-Hexanediol | 3.0 | 3.0 | 3.0 |
| | | Triethylene glycol | 1.5 | 1.5 | 1.5 |
| | | PEG1K | 3.0 | 3.0 | 3.0 |
| | | ACETYLENOL E100 | 1.0 | 1.0 | 1.0 |
| | | Water | 53.5 | 53.5 | 53.5 |
| Content (%) of PY74(P1) in ink | | | 4.5 | 4.5 | 4.5 |
| Content (%) of pigment | | | 0.045 | 0.045 | 0.090 |
| derivative (P2) in ink | | | | | |
| | Detail of P2 | P2-A(mg/L) | 46 | 51 | 203 |
| | | P2-B(mg/L) | 230 | 239 | 421 |
| | | P2-C(mg/L) | 174 | 160 | 276 |

| | | | |
|---|---|---|---|
| P2/P1(%) | 1.00 | 1.00 | 2.00 |
| (P2-B)/P1(%) | 0.51 | 0.53 | 0.94 |
| (P2-C)/P1(%) | 0.39 | 0.36 | 0.61 |
| Width at half maximum | 0.29 | 0.29 | 0.29 |
| Peak intensity ratio | 0.97 | 0.97 | 0.97 |
| Adsorption resin/ | 5% | 30% | 12% |
| (P1 + P2-B, C) (%) | | | |
| Unit derived from monomer | 50 | 50 | 50 |
| having aromatic ring (%) | | | |

| | | Comparative Examples | | | | | |
|---|---|---|---|---|---|---|---|
| | | 1 | 2 | 3 | 4 | 5 | 6 |
| Type of pigment dispersion liquid | | D7 | D7 | D7 | D11 | D12 | D13 |
| Type of pigment derivative | | — | P2-6 | P2-5 | P2-5 | P2-5 | P2-7 |
| Formulation | Pigment dispersion | 30.0 | 30.0 | 30.0 | 30.0 | 30.0 | 30.0 |
| of ink | liquid | | | | | | |
| components | Pigment derivative | — | 0.045 | 0.009 | — | — | — |
| (part(s)) | Glycerin | 8.0 | 8.0 | 8.0 | 8.0 | 8.0 | 8.0 |
| | 1,2-Hexanediol | 3.0 | 3.0 | 3.0 | 3.0 | 3.0 | 3.0 |
| | Triethylene glycol | 1.5 | 1.5 | 1.5 | 1.5 | 1.5 | 1.5 |
| | PEG1K | 3.0 | 3.0 | 3.0 | 3.0 | 3.0 | 3.0 |
| | ACETYLENOL E100 | 1.0 | 1.0 | 1.0 | 1.0 | 1.0 | 1.0 |
| | Water | 53.5 | 53.5 | 53.5 | 53.5 | 53.5 | 53.5 |
| Content (%) of PY74(P1) in ink | | 4.5 | 4.5 | 4.5 | 4.5 | 4.5 | 4.5 |
| Content (%) of pigment | | 0 | 0.045 | 0.009 | 0.045 | 0.135 | 0.180 |
| derivative (P2) in ink | | | | | | | |
| Detail of P2 | P2-A(mg/L) | 0 | 432 | 18 | 59 | 378 | 504 |
| | P2-B(mg/L) | 0 | 9 | 86 | 86 | 441 | 588 |
| | P2-C(mg/L) | 0 | 9 | 32 | 306 | 531 | 708 |

| | | | | | | |
|---|---|---|---|---|---|---|
| P2/P1(%) | 0.00 | 1.00 | 0.20 | 1.00 | 3.00 | 4.00 |
| (P2-B)/P1(%) | 0.00 | 0.02 | 0.19 | 0.19 | 0.98 | 1.31 |
| (P2-C)/P1(%) | 0.00 | 0.02 | 0.07 | 0.68 | 1.18 | 1.57 |
| Width at half maximum | 0.29 | 0.29 | 0.29 | 0.29 | 0.29 | 0.29 |
| Peak intensity ratio | 0.97 | 0.97 | 0.97 | 0.97 | 0.97 | 0.97 |
| Adsorption resin/ | 11% | 12% | 12% | 13% | 13% | 40% |
| (P1 + P2-B, C) (%) | | | | | | |
| Unit derived from monomer | 50 | 50 | 50 | 50 | 50 | 56 |
| having aromatic ring (%) | | | | | | |

### <Evaluation>

Each ink obtained above was packed in an ink cartridge, and set in an inkjet recording apparatus (trade name “PIXUS PRO-10S”, manufactured by CANON KABUSHIKIKAISHA) in which a recording head for discharging the ink by heat energy was mounted. In the present Examples, an image recorded in a condition for providing 8 droplets (about 30 ng) of the ink, wherein the mass per droplet of the ink is 3.8 ng, onto a unit region of 1/600 inches× 1/600 inches is defined as having a recording duty of 100%. In the present disclosure, “AA”, “A” and “B” were defined as acceptable levels and “C” was defined as an unacceptable level in the evaluation criteria with respect to each item shown below. The evaluation results are shown in Table 7 (Tables 7-1 to 7-4).

### (Fixation Recoverability)

A printer driver of the above inkjet recording apparatus was operated to perform a recovery operation (cleaning). Next, a supply cable was withdrawn during the operation of a carriage, thereby providing a state where no capping was applied to the recording head. The state was kept and the inkjet recording apparatus was placed in an environment at a temperature of 30° C. and a relative humidity of 10% for 14 days. Thereafter, the recovery operation (cleaning) of the inkjet recording apparatus was again performed and a nozzle check pattern of “PIXUS PRO-1 OS” was recorded. The nozzle check pattern recorded was visually observed and fixation recoverability was evaluated according to the following evaluation criteria.
AA: a normally recordable state was achieved by one recovery treatment.
A: a normally recordable state was achieved by two recovery treatments.
B: a normally recordable state was achieved by three recovery treatments.
C: a normally recordable state was not achieved even by three or more recovery treatments.

### (Light Resistance of Image)

The above inkjet recording apparatus was used to record 15 types of solid images in which the recording duty was varied at an interval of 10% between 0% and 140%, on a recording medium (trade name “CANON Photo Paper, Glossy Gold GL-101”, manufactured by CANON KABUSHIKI KAISHA). The images recorded were dried at 25° C. for 24 hours, and thereafter a fluorescence spectral density meter (trade name “FD-7”, manufactured by KONICA MINOLTA, INC.) was used to measure the spectral sensitivity characteristics of the images with respect to the respective recording duties, thereby identifying an image having a spectral density closest to 1.0. The spectral sensitivity characteristic is the spectral density of a yellow component prescribed by “ISO Status A”. A recording medium on which an image for evaluation was recorded was placed in alight resistance testing apparatus (trade name “Xenon Weather Meter X75SC”, manufactured by Suga Test Instruments Co., Ltd.) and irradiated with xenon light for 300 hours. The conditions here are as follows: wavelength of xenon light: 340 nm, irradiation intensity: 0.39 W/(m²·nm), black panel temperature: 60° C. and relative humidity: 70%.

The optical density of the image after irradiation was measured and also the “percentage (%) of the residual optical density” was calculated from the following expression (4), and the light resistance of the image was evaluated according to the following evaluation criteria.

$$Percentage ( \% ) of residual optical density = \{ ( Optical density after irradiation ) / ( Optical density before irradiation ) \} \times 100 \qquad ( 4 )$$

A: a percentage of the residual optical density of 75% or more.
B: a percentage of the residual optical density of 50% or more and less than 75%.
C: a percentage of the residual optical density of less than 50%.

### (Amount of Foreign Substance Around Discharge Port)

The above inkjet recording apparatus was used to record a solid image of 19 cm×26 cm, having a recording duty of 100%, on two sheets of plain paper (PPC Paper GF-500, manufactured by CANON KABUSHIKI KAISHA). After the inkjet recording apparatus was left to stand for 30 minutes, the recording head was detached and a discharge port surface was observed with a microscope. Furthermore, the recording head was again loaded in the inkjet recording apparatus and the same image as described above was recorded on two sheets, and such a process was defined as one cycle and repeated for 20 cycles. Thereafter, a nozzle check pattern of PIXUS PRO-10S was recorded on one sheet.

The nozzle check pattern here was visually observed to evaluate suppression of discharge shift. Furthermore, the recording head was detached and a discharge port surface was observed with a microscope. The amount of foreign substances around the discharge port was evaluated by confirming foreign substance (fouling) on the discharge port surface.
AA: no fouling was observed on the discharge port surface and no disruption was confirmed in the nozzle check pattern.
A: slight fouling was observed on the discharge port surface, but no disruption was confirmed in the nozzle check pattern.
B: slight fouling was observed on the discharge port surface and one disruption was confirmed in the nozzle check pattern.
C: fouling was observed on the discharge port surface and two or more disruptions were confirmed in the nozzle check pattern.

### (Stability of Rate of Ink Discharge)

Each ink obtained above was packed in an ink cartridge, and set in an inkjet recording apparatus (trade name “PIXUS PRO-10S”, manufactured by CANON KABUSHIKIKAISHA) in which a recording head for discharging the ink by heat energy was mounted. Any five discharge ports of the recording head were selected, continuous discharge of the ink was performed at a frequency of 50,000 times/sec, an ink droplet discharged was imaged from a lateral direction and the rate of discharge of the ink droplet was calculated by image processing. The rate of discharge of the ink droplet after each predetermined time (after 1 minute, after 3 hours) from the start of continuous discharge was calculated. The “change in rate of discharge” with respect to each of the discharge ports was calculated based on the expression {“Rate of discharge of ink droplet after one minute”−“Rate of discharge of ink droplet after 3 hours” }/{“Rate of discharge of ink droplet after one minute” }. The average of “change in rate of discharge” with respect to the five discharge ports was determined, the percentage of the change in rate of discharge was calculated and the stability of the rate of the ink discharge was evaluated according to the following evaluation criteria. A smaller percentage of the change in rate of discharge means higher stability of the rate of the ink discharge. On the contrary, for example, if a foreign substance along with pigment precipitation is generated on the surface of a heating portion (heater) in an ink liquid chamber and/or the surface of an ink passage in the recording head, the rate of discharge of the ink decreases and the percentage of the change in rate of discharge increases.
A: a percentage of the change in rate of discharge of 0.05 or less.
B: a percentage of the change in rate of discharge of more than 0.05 and 0.20 or less.
C: a percentage of the change in rate of discharge of more than 0.20.

### (Storage Stability)

The inks prepared were each encapsulated, and left to stand and stored in a constant-temperature bath at 60° C. for one month. Each of the inks after storage was evaluated about the fixation recoverability and the amount of a foreign substance discharged, in the same manner as in evaluation before storage. The storage stability was evaluated according to the following evaluation criteria.
A: evaluation ranks of the fixation recoverability and the amount of a foreign substance discharged were comparable with the evaluation ranks before storage.
B: one of evaluation ranks of the fixation recoverability and the amount of a foreign substance discharged was lowered as compared with the evaluation ranks before storage.
C: both of evaluation ranks of the fixation recoverability and the amount of a foreign substance discharged were lowered as compared with the evaluation ranks before storage.

TABLE 7-1

| | Examples | | | | | | |
|---|---|---|---|---|---|---|---|
| | 1 | 2 | 3 | 4 | 5 | 6 | 7 |
| Fixation recoverability | B | B | B | A | A | AA | A |
| Light resistance of image | B | B | B | B | B | A | A |
| Amount of foreign substance around | B | B | B | A | A | AA | A |
| discharge port | | | | | | | |
| Stability of rate of ink discharge | B | B | B | B | B | A | A |
| Storage stability | B | B | B | B | B | B | A |

TABLE 7-2

| | Examples | | | | | | | |
|---|---|---|---|---|---|---|---|---|
| | 8 | 9 | 10 | 11 | 12 | 13 | 14 | 15 |
| Fixation recoverability | AA | AA | A | A | AA | AA | AA | AA |
| Light resistance of image | A | A | B | A | B | A | A | A |
| Amount of foreign substance around | AA | AA | A | A | AA | AA | AA | AA |
| discharge port | | | | | | | | |
| Stability of rate of ink discharge | A | A | B | A | A | A | A | A |
| Storage stability | B | B | B | A | A | A | A | A |

TABLE 7-3

Examples

| | 16 | 17 | 18 |
|---|---|---|---|
| Fixation | AA | AA | AA |
| recoverability | | | |
| Light resistance of | A | A | A |
| image | | | |
| Amount of foreign | AA | AA | A |
| substance around | | | |
| discharge port | | | |
| Stability of rate of | A | A | A |
| ink discharge | | | |
| Storage stability | A | A | A |

TABLE 7-4

| | Comparative Examples | | | | | |
|---|---|---|---|---|---|---|
| | 1 | 2 | 3 | 4 | 5 | 6 |
| Fixation recoverability | C | C | C | C | B | B |
| Light resistance of image | B | B | B | B | C | C |
| Amount of foreign substance around | C | C | C | C | B | B |
| discharge port | | | | | | |
| Stability of rate of ink discharge | B | B | B | B | C | C |
| Storage stability | A | A | A | A | A | A |

According to the present disclosure, there can be provided an aqueous ink which is favorable in fixation recoverability, which enables an image excellent in light resistance to be recorded, which less causes a foreign substance even if discharged through a thermal-type recording head and which is favorable in stability of the rate of discharge. In addition, according to the present disclosure, there can be provided an ink cartridge and an inkjet recording method in which the aqueous ink is used.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-035132, filed Mar. 6, 2025, and Japanese Patent Application No. 2026-030492, filed Feb. 27, 2026, which are hereby incorporated by reference herein in their entirety.

What is claimed is:

1. An aqueous ink for inkjet, comprising C.I. Pigment Yellow 74 and a compound represented by the following general formula (1), wherein
a mass ratio of the compound represented by the general formula (1) adsorbed onto the C.I. Pigment Yellow 74 to the C.I. Pigment Yellow 74 present in the aqueous ink is 0.20% by mass or more, and
a mass ratio of the compound represented by the general formula (1) present inside the C.I. Pigment Yellow 74 to the C.I. Pigment Yellow 74 present in the aqueous ink is 0.70% by mass or less: 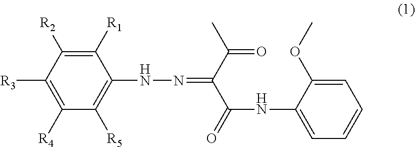
wherein R₁ to R₅ each independently represent a hydrogen atom, a halogen atom, an alkyl group, an alkyl halide group, an alkoxy group, an acyl group, an aryl group, a nitro group, an alkoxycarbonyl group, an acyloxy group, a hydroxy group, an amino group, or a carboxy group, a sulfo group, a phosphoric acid group or a salt thereof; or alternatively, R₁ and R₂ can be bonded to each other to form an aromatic ring together with carbon atoms to which R₁ and R₂ are bonded; and at least one of R₁ to R₅ is a hydroxy group, an amino group, or a carboxy group, a sulfo group, a phosphoric acid group or a salt thereof.

2. The aqueous ink according to claim 1, wherein the compound represented by the general formula (1) is a compound represented by the following general formula (2) or (3). 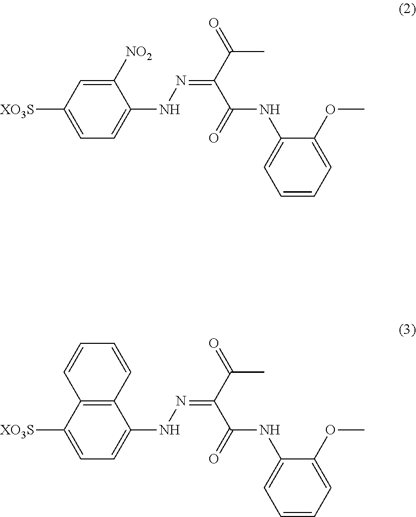
wherein X represents a counterion when —SO₃X is of the salt type and represents a hydrogen atom when —SO₃X is of the acid type.

3. The aqueous ink according to claim 1, wherein, in an X-ray diffraction spectrum of a mixture of the C.I. Pigment Yellow 74 and the compound represented by the general formula (1) in the ink,
a width at half maximum of a diffraction peak located at diffraction angle 2θ=11.6±0.2° is 0.50° or less, and
a ratio of a diffraction peak intensity at diffraction angle 2θ=11.6±0.2° to a diffraction peak intensity at diffraction angle 2θ=26.8±0.2° is 0.90 or more.

4. The aqueous ink according to claim 1, further comprising a resin, wherein
the resin comprises a copolymer having a unit derived from a monomer having an aromatic ring, and
a content (% by mass) of the unit derived from a monomer having an aromatic ring in the copolymer is 60% by mass or more and 80% by mass or less based on a total mass of the copolymer.

5. The aqueous ink according to claim 4, wherein an amount of adsorption of the resin adsorbed onto the C.I. Pigment Yellow 74 is 0.05% by mass or more and 30.0% by mass or less based on a total content of the C.I. Pigment Yellow 74 and the compound represented by the general formula (1) in the aqueous ink.

6. An ink cartridge comprising an ink and an ink storage portion that houses the ink, wherein
the ink is an aqueous ink for inkjet, the aqueous ink comprising C.I. Pigment Yellow 74 and a compound represented by the following general formula (1),
a mass ratio of the compound represented by the general formula (1) adsorbed onto the C.I. Pigment Yellow 74 to the C.I. Pigment Yellow 74 present in the aqueous ink is 0.20% by mass or more, and
a mass ratio of the compound represented by the general formula (1) present inside the C.I. Pigment Yellow 74 to the C.I. Pigment Yellow 74 present in the aqueous ink is 0.70% by mass or less: 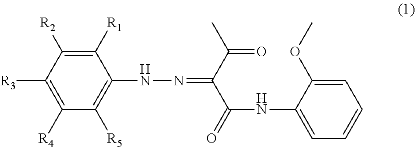
wherein R₁ to R₅ each independently represent a hydrogen atom, a halogen atom, an alkyl group, an alkyl halide group, an alkoxy group, an acyl group, an aryl group, a nitro group, an alkoxycarbonyl group, an acyloxy group, a hydroxy group, an amino group, or a carboxy group, a sulfo group, a phosphoric acid group or a salt thereof; or alternatively, R₁ and R₂ can be bonded to each other to form an aromatic ring together with carbon atoms to which R₁ and R₂ are bonded; and at least one of R₁ to R₅ is a hydroxy group, an amino group, or a carboxy group, a sulfo group, a phosphoric acid group or a salt thereof.

7. An inkjet recording method comprising discharging an ink through an inkjet-type recording head to record an image on a recording medium, wherein
the ink is an aqueous ink for inkjet, the aqueous ink comprising C.I. Pigment Yellow 74 and a compound represented by the following general formula (1),
a mass ratio of the compound represented by the general formula (1) adsorbed onto the C.I. Pigment Yellow 74 to the C.I. Pigment Yellow 74 present in the aqueous ink is 0.20% by mass or more, and
a mass ratio of the compound represented by the general formula (1) present inside the C.I. Pigment Yellow 74 to the C.I. Pigment Yellow 74 present in the aqueous ink is 0.70% by mass or less: 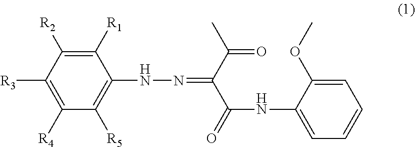
wherein R₁ to R₅ each independently represent a hydrogen atom, a halogen atom, an alkyl group, an alkyl halide group, an alkoxy group, an acyl group, an aryl group, a nitro group, an alkoxycarbonyl group, an acyloxy group, a hydroxy group, an amino group, or a carboxy group, a sulfo group, a phosphoric acid group or a salt thereof, or alternatively, R₁ and R₂ can be bonded to each other to form an aromatic ring together with carbon atoms to which R₁ and R₂ are bonded; and at least one of R₁ to R₅ is a hydroxy group, an amino group, or a carboxy group, a sulfo group, a phosphoric acid group or a salt thereof.
